(19) United States
(12) Patent Application Publication
(10) Pub. No.: US 2026/0134343 A1
(43) Pub. Date: May 14, 2026

(54) GENERATIVE VISION LANGUAGE ACTION MODELS FOR INTERACTIVE APPLICATIONS AND SYSTEMS

(71) Applicant: NVIDIA Corporation, Santa Clara, CA (US)

(72) Inventors: Ekta Prashnani, San Jose, CA (US); Iuri Frosio, Bergamo (IT); Scott Kim, Fremont, CA (US); Leonard Salewski, Tübingen (DE)

(21) Appl. No.: 18/958,600

(22) Filed: Nov. 25, 2024

(30) Foreign Application Priority Data
Nov. 8, 2024 (IT) 102024000025164

(51) Int. Cl. G06N 20/00; G06F 40/40

(52) U.S. Cl. CPC G06N 20/00; G06F 40/40

(57) ABSTRACT

In various examples, action models for interactive applications and systems are described herein. Systems and methods are disclosed that generate a training dataset using data from one or more sources, such as application services and/or content sharing services. As described herein, the training dataset may include videos, input information (e.g., actions taken), textual information, and/or any other type of information that is retrieved and/or generated using one or more processing pipelines. Systems and methods are also disclosed that use the training dataset to train one or more machine learning models—such as one or more vision-language-action (VLA) models—to perform one or more tasks. For example, after training, the VLA model(s) may process input data associated with an application, such as video frames, received inputs and/or actions, and/or previous instructions, and predict at least additional instructions to perform with regard to the application.

### CROSS-REFERENCE TO RELATED APPLICATIONS

This application claims the benefit of Italian Patent Application No. 102024000025164, filed Nov. 8, 2024, which is hereby incorporated by reference in its entirety.

### BACKGROUND

Language models—such as vision-language models—can be used to process images in order to generate text that describes scenes and/or objects depicted by the images. For example, if an image depicts a vehicle navigating along a roadway, a language model may generate text that describes at least the vehicle, the roadway, and a background as depicted by the image. However, these language models may be inaccurate and/or inefficient in certain situations—such as when generating text describing interactive applications (e.g., gaming applications) or when generating instructions for agents (e.g., robots) to perform—which require understanding a context associated with the scene. For example, if a language model is provided with images from a gaming application and then asked what action should be taken next, the language model may generate instructions for the action that are wrong, unviable, and/or ineffective.

### SUMMARY

Embodiments of the present disclosure relate to generative models for interactive applications and systems. Systems and methods are disclosed that generate a training dataset using data from one or more sources, such as application services (e.g., a cloud gaming service), content sharing services, and/or any other type of content source. As described herein, the training dataset may include—without requirement or restriction—videos, input information (e.g., inputs received, actions taken, signal sent, etc.), textual information (e.g., instructions, descriptions, etc.), and/or any other type of information that is retrieved from the source(s) and/or generated using one or more processing pipelines. Systems and methods are also disclosed that use the training dataset to train one or more machine learning models—such as one or more vision-language-action (VLA) models—to perform one or more tasks. For example, after training, the VLA model(s) may process input data associated with an application, such as video frames, received inputs and/or actions, and/or previous instructions. The VLA model(s) may then predict information associated with the application, such as previous, current, and/or future instructions, inputs, actions, and/or frames associated with the application.

In contrast to conventional systems, the systems of the present disclosure, in some embodiments, may train the VLA model(s) using various types of training data, such as videos, inputs received and/or corresponding actions taken, and/or textual information (e.g., instructions). As such, the systems of the present disclosure train the VLA model(s) to better understand context associated with applications such that the VLA model(s) is able to accurately predict information, such as future instructions and/or actions that should be performed with regard to the applications. Additionally, in contrast to conventional systems, the systems of the present disclosure, in some embodiments, automatically generate a training dataset that includes the various types of training data for training the model(s). For instance, and as described herein, the systems of the present disclosure may retrieve at least a portion of the training data from the source(s), such as videos, inputs/actions, and/or audio, and then use one or more processing pipelines to automatically generate an additional portion of the training data, such as the textual information.

Additionally, in some embodiments, the systems of the present disclosure may be used to train a new VLA model(s) to perform specific tasks, such as predicting information, and/or to further train an existing model(s) to perform additional tasks, such as predicting the inputs and/or actions described herein. For example, the systems of the present disclosure may be used for fine-tuning a VLA model(s) to determine actions to perform with regard to an interactive application. This may provide improvements over conventional systems, such as by requiring less training data for fine-tuning a VLA model(s) to perform such tasks.

### BRIEF DESCRIPTION OF THE DRAWINGS

The present systems and methods for action models for interactive applications and systems are described in detail below with reference to the attached drawing figures, wherein:

FIG. 1 illustrates an example of a process for generating one or more datasets to train one or more vision-language-action (VLA) models, in accordance with some embodiments of the present disclosure;

FIG. 2A illustrates an example of a first process for generating additional training data associated with one or more applications, in accordance with some embodiments of the present disclosure;

FIG. 2B illustrates an example of generating a prompt associated with an instance of training data, in accordance with some embodiments of the present disclosure;

FIG. 2C illustrates an example of an instruction associated with a frame of a gaming application, in accordance with some embodiments of the present disclosure;

FIG. 2D illustrates an example of synchronizing instructions with sets of frames, in accordance with some embodiments of the present disclosure;

FIG. 3A illustrates an example of a second process for generating additional training data associated with one or more applications, in accordance with some embodiments of the present disclosure;

FIG. 3B illustrates an example of determining user speech that is associated with a primary user, in accordance with some embodiments of the present disclosure;

FIG. 3C illustrates an example of determining whether text is relevant to a video, in accordance with some embodiments of the present disclosure;

FIG. 4A illustrates a data flow diagram illustrating a process for training one or more machine learning models to provide information associated with applications, in accordance with some embodiments of the present disclosure;

FIGS. 4B-4C illustrate examples of measuring loss associated training the one or more machine learning models, in accordance with some embodiments of the present disclosure;

FIG. 5A illustrates an example of a process of using one or more machine learning models to provide information associated with an application, in accordance with some embodiments of the present disclosure;

FIG. 5B illustrates an example of providing instructions associated with an application, in accordance with some embodiments of the present disclosure;

FIG. 6 illustrates an example of one or more machine learning models processing data to generate outputs, in accordance with some embodiments of the present disclosure;

FIG. 7 illustrates a flow diagram showing a method for training one or more machine learning models to generate information associated with applications, in accordance with some embodiments of the present disclosure;

FIG. 8 illustrates a flow diagram showing a method for using one or more machine learning models to generate information associated with applications, in accordance with some embodiments of the present disclosure;

FIG. 9A is a block diagram of an example generative language model system suitable for use in implementing at least some embodiments of the present disclosure;

FIG. 9B is a block diagram of an example generative language model that includes a transformer encoder-decoder suitable for use in implementing at least some embodiments of the present disclosure;

FIG. 9C is a block diagram of an example generative language model that includes a decoder-only transformer architecture suitable for use in implementing at least some embodiments of the present disclosure;

FIG. 10 is a block diagram of an example content streaming system suitable for use in implementing some embodiments of the present disclosure;

FIG. 11 is a block diagram of an example computing device suitable for use in implementing at least some embodiments of the present disclosure; and

FIG. 12 is a block diagram of an example data center suitable for use in implementing at least some embodiments of the present disclosure.

### DETAILED DESCRIPTION

Systems and methods are disclosed related action models for interactive applications and systems. For instance, a system(s) may retrieve training data for generating one or more datasets from one or more sources. As described herein, a source may include, but is not limited to, an application service (e.g., a cloud gaming service, etc.), a content sharing service (e.g., a video sharing service, an application sharing service, a game sharing service, etc.), a user device, and/or any other type of source for which data may be retrieved. Additionally, the training data may include, but is not limited to, video data representing videos (e.g., frames) corresponding to one or more applications, input data representing inputs received and/or actions performed with regard to the videos, audio data representing user speech describing the videos, and/or any other type of data. Furthermore, an application may be, include, or be included as a feature of one or more applications such as —-without limitation —-an interactive application (e.g., a gaming application, a collaborative content creation application, a machine-controlling application, etc.), a multimedia application (e.g., a video streaming application, a music streaming application, a voice streaming application, a multimedia streaming application that includes both audio and video, etc.), a communications application (e.g., a video conferencing application, etc.), an educational application, or any other type of application.

The system(s) may then process at least a portion of the training data using one or more processing pipelines to generate additional training data.. As described herein, in some examples, the additional training data may include new training data, an augmentation of the already obtained training data from the source(s), and/or both. For a first example, if training data includes videos along with corresponding audio representing user speech, then the system(s) may augment the training data with language (e.g., instructions) that is relevant to the videos. For a second example, if training data includes videos along with corresponding inputs, then the system(s) may augment the training data with language (e.g., instructions) that are relevant to the videos and/or the inputs. In other words, at least a portion of the initial training data obtained from the source(s) may be missing data types that are relevant for later training machine learning models, which is described in more detail herein, and the system(s) may augment the training data with the missing types of data using one or more of the processes described herein.

For example, if training data received from a source (e.g., a content sharing source) includes a video along with corresponding audio data representing user speech from one or more users, the system(s) may process the training data using a first processing pipeline that is configured to identify language from the user speech that is relevant to the video and/or the application. As described herein, language may be relevant to the video and/or the application when the language describes what is occurring with respect to the video, such as inputs being received and/or actions being taken. For example, if the video is associated with a gaming application, then language may be relevant if the language describes one or more actions that a user is taking, such as how the user is moving an object (e.g., a player, a vehicle, etc.) and/or a task that the user is attempting to accomplish.

The first processing pipeline may use one or more models and/or other components to process the training data in order to identify the relevant language. For instance, the first processing pipeline may use one or more speaker recognition models that process the audio data to identify respective speech associated with each of the user(s). The first processing pipeline may then identify a portion of the user speech that is associated with a primary user, such as based on how much each user speaks (e.g., select the user that speaks the most). The first processing pipeline may also use one or more language models that process a transcript associated with the identified speech to filter out speech that is not associated with a specific language and/or includes specific words, such as inappropriate words. Additionally, the first processing pipeline may then use one or more additional models (e.g., one or more vision-language models) that process the filtered transcript to identify the language that is relevant to the video and/or the application. For instance, the additional model(s) may be prompted to identify the relevant language, such as by outputting an indication of whether language is relevant (e.g., yes) or an indication of whether language is not relevant (e.g., no). The first processing pipeline may then output the relevant language associated with the training data. Additionally, the system(s) may use the first processing pipeline to identify relevant language associated with additional instances of the training data.

Additionally, in some examples, if the training data received from a source (e.g., a cloud gaming service) includes a video along with corresponding input data representing inputs received by a user device and/or actions taken that correspond to the inputs, the system(s) may process the training data using a second processing pipeline that is configured to generate language associated with the video. As described herein, the language may describe instructions that correspond to the actions being taken with regard to the video, such as instructions for how to proceed. For example, if the video is associated with a gaming application and depicts a vehicle making a right turn, then the language may include an instruction to turn the vehicle right. To generate the language for the video, the second processing pipeline may use one or more models.

For instance, the system(s) may generate input data for the model(s) using information associated with the video, information associated with the application, and/or a prompt associated with generating the language. For example, the input data may represent at least the frames from the video, the inputs received and/or actions taken, associations between inputs and actions, one or more descriptions associated with the application, one or more captions describing the frames, location information for one or more objects depicted by the frame(s), and the prompt to generate an instruction describing what is occurring with respect to the frames. The model(s) may then process the input data and, based at least on the processing, generate and/or output data representing the language (e.g., the instruction(s)) associated with the video. Additionally, the system(s) may use the second processing pipeline to generate additional language associated with additional instances of the training data.

In some examples, the system(s) may synchronize the inputs, actions, and/or the generated language with the frames of the videos. For an example of synchronizing inputs and/or actions, the system(s) may use timestamps associated with the inputs and/or actions along with timestamps associated with the frames to align the inputs and/or actions with the frames. As described herein, an input may be aligned with a frame that was being displayed when the input was received, a frame that depicts the action associated with the input, and/or any other frame. For an example of synchronizing generated language, the system(s) may align the language with one or more frames that precede the frame(s) for which the language was initially generated. In some examples, the language may be aligned with the preceding frame(s) since the language describes instructions that should occur next based on the scenario represented by the preceding frame(s).

The system(s) may then use the dataset(s) that includes the training data (e.g., the retrieved training data, the generated training data, etc.) to train one or more models. As described herein, the model(s) may be referred to as the vision-language-action (VLA) model(s) since the VLA model(s) is able to process visual data (e.g., frames), textual data (e.g., language, such as instructions), and input data (e.g., inputs received, actions performed, etc.). For instance, and for an instance of training data that includes one or more video frames, one or more inputs, and language, the system(s) may apply the training data to the VLA model(s). The VLA model(s) may then process the training data and, based at least on the processing, generate and/or output one or more instructions that should be performed next with respect to the application. For example, if the video frame(s) is associated with a gaming application and depicts a vehicle approaching a right turn, then the instruction(s) may be associated with turning the vehicle right. The system(s) may then determine one or more losses based at least on comparing the output instruction(s) to one or more ground truth instructions (e.g., the identified and/or generated language) and update the parameters and/or weights of the VLA model(s) using the loss(es). Additionally, the system(s) may perform similar processes for one or more additional instances of the training data.

In some examples, the VLA model(s) may be trained to generate and/or output additional data. For example, the VLA model(s) may be trained to generate and/or output data representing inputs (e.g., actions) for performing the instructions, frames depicting the instructions as performed, text describing the frames, and/or any other information. As described herein, in some examples, the output data may be associated with previous states of the application, current states of the application, and/or future states of the application. For a first example, output data may represent one or more previous inputs applied to an application and/or one or more previous frames associated with the application, such as frames that are missing (e.g., dropped frames). For a second example, output data may represent one or more future inputs that should be applied to the application and/or one or more future frames that should be presented based on the future input(s) being applied to the application. In other words, the VLA model(s) may be trained to generate and/or output any data representing instructions, inputs, actions, and/or frames associated with an application.

Additionally, in some examples, since some of the training data used as ground truth during training may be missing one or more types of data, such as when training data associated with the content sharing services is missing the inputs and/or actions associated with the videos and/or when training data associated with the application service is missing instructions and/or descriptions, one or more techniques may be used to train the VLA model(s) to operate despite the missing ground truth data. For example, and as described in more detail herein, the system(s) may mask at least some of the inputs provided as ground truth data samples to the VLA model(s), when performing the training.

As described herein, the system(s) (and/or one or more additional systems, user devices, and/or any other computing device) may then use the VLA model(s) to perform one or more tasks. For instance, and with regard to an interactive application, such as a gaming application, the system(s) may use the VLA model(s) to determine at least instructions that should be performed with regard to a session associated with the interactive application. For example, at an instance of the session, the system(s) may input data into the VLA model(s), such as input data representing one or more depicted frames, one or more received inputs, and/or one or more previous instructions. The VLA model(s) may then process the input data and generate output data representing at least one or more instructions that should be performed next with regard to the session. For example, if the interactive application again includes a gaming application and the frame(s) depict(s) a character approaching an important item, then the generated instruction(s) may be associated with walking over and retrieving the item. The system(s) may then continue using the VLA model(s) to continue generating instructions to be performed during the session.

In some examples, the VLA model(s) may generate additional data associated with the session. For instance, the VLA model(s) may generate data representing inputs associated with the instructions, such as inputs that will cause the instructions to be performed with respect to the interactive application. For example, and using the example above where the instruction(s) is associated with walking over and retrieving the item, the inputs may be associated with one or more actions that cause the character to approach the item and/or retrieve the item. Additionally, or alternatively, the VLA model(s) may generate data representing frames depicting the instructions being performed. For example, and again using the example above where the instruction(s) is associated with walking over and retrieving the item, the frames may depict the character approaching the item and/or retrieving the item. While these are just a few examples of additional data that may be generated and/or output by the VLA model(s), in other examples, the VLA model(s) may generate and/or output any other type of data.

In some examples, the VLA model(s) may be used with other types of technology. For instance, the VLA model(s) may be used to control machines—such as vehicles and/or robots—by providing instructions, inputs, commands, and/or signals for controlling the vehicles and/or robots. For example, data may be input into the VLA model(s), such as video data representing an environment surrounding a machine, input data representing inputs received and/or actions performed by the machine (e.g., command signals provided to the machine), audio data representing one or more tasks to be performed by the machine (e.g., from one or more users), and/or any other data. The VLA model(s) may then process the data and generate output data representing one or more instructions for performing the task(s) and/or one or more signals to send to the machine to perform actions associated with the instructions. For example, if the machine includes a robot and the task is to pick an item up off a table, then the instruction(s) may direct the robot to walk over to the table, identify the location of the item on the table, and pick the item off the table.

In some examples, the model(s) may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the model(s) is small enough (e.g., has a small enough number of parameters), the model(s) may be included within the container itself. In some embodiments, the model(s) described herein may be deployed as an inference microservice to accelerate deployment of models on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the model(s) (e.g., that has been optimized for high performance inference), an inference runtime software to execute the model(s) and provide outputs/responses to inputs, and enterprise management software to provide health checks, identity, and other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing one or more visual language models (VLMs), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

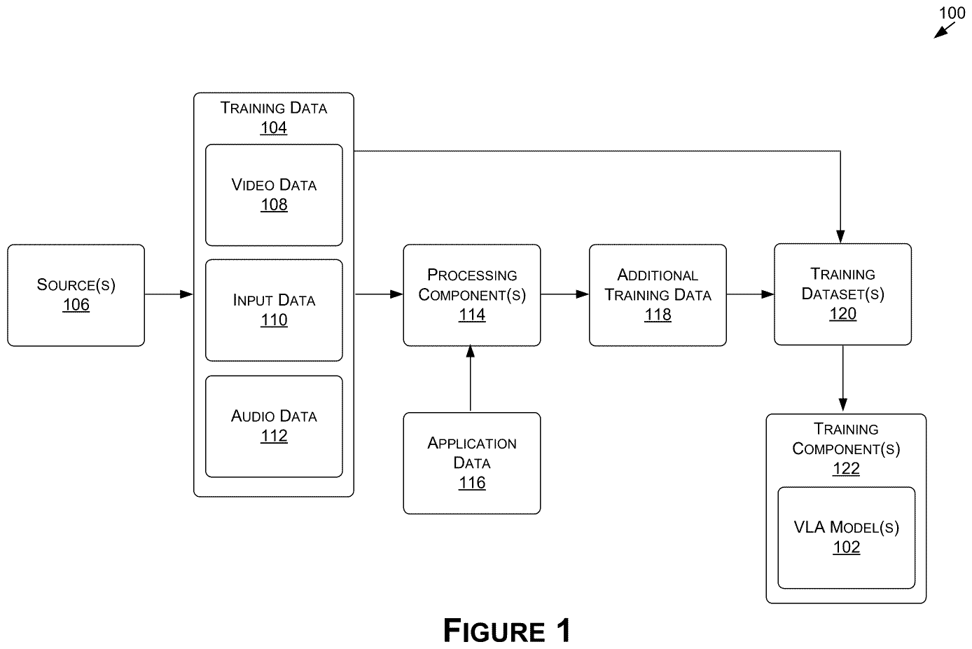

With reference to FIG. 1, FIG. 1 illustrates an example of a process 100 for generating one or more datasets to train one or more vision-language-action (VLA) models, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The process 100 may include receiving training data 104 from one or more sources 106 associated with one or more applications. As described herein, a source 106 may include, but is not limited to, an application service (e.g., a cloud gaming service, etc.), a content sharing service (e.g., a video sharing service, an application sharing service, a game sharing service, etc.), a user device, and/or any other type of source for which data may be retrieved. Additionally, the training data 104 may include, but is not limited to, video data 108 representing videos (e.g., frames) corresponding to one or more applications, input data 110 representing inputs received and/or actions performed with respect to the videos, audio data 112 representing user speech describing the videos, and/or any other type of data. Furthermore, an application may be, include, or be included as a feature of, without limitation, an interactive application (e.g., a gaming application, a collaborative content creation application, a machine-controlling application, etc.), a multimedia application (e.g., a video streaming application, a music streaming application, a voice streaming application, a multimedia streaming application that includes both audio and video, etc.), a communications application (e.g., a video conferencing application, etc.), an educational application, or any other type of application.

The process 100 may then include one or more processing components 114 processing at least a portion of the training data 104 and/or application data 116 associated with the one or more applications to generate additional training data 118. As described herein, in some examples, the additional training data 118 may include new training data, an augmentation of the already obtained training data from the source(s) 106, and/or both. For a first example, if training data 104 includes videos along with corresponding audio representing user speech, then the additional training data 118 may represent language (e.g., instructions) that is relevant to the videos. For a second example, if training data 104 includes videos along with corresponding inputs, then the additional training data 118 may represent language (e.g., instructions) that are relevant to the videos and/or the inputs. In other words, at least a portion of the initial training data 104 obtained from the source(s) 106 may be missing data types that are relevant for later training machine learning models, which is described in more detail herein, and the additional training data 118 may augment the training data 104 with the missing types of data using one or more of the processes described herein.

As described herein, a processing component 114 may include, but is not limited to, a processing pipeline, a machine learning model, a neural network, an algorithm, a module, software, and/or any other type of processing component that may be configured to perform one or more of the processes described herein. Additionally, instances of the training data 104 may be processed differently based on the types of data that are included within the instances of training data 104. For example, instances of training data 104 that include video data 108 and input data 110 may be processed using one or more first processing components 114 while instances of training data 104 that include video data 108 and audio data 112 may be processed using one or more second processing components 114.

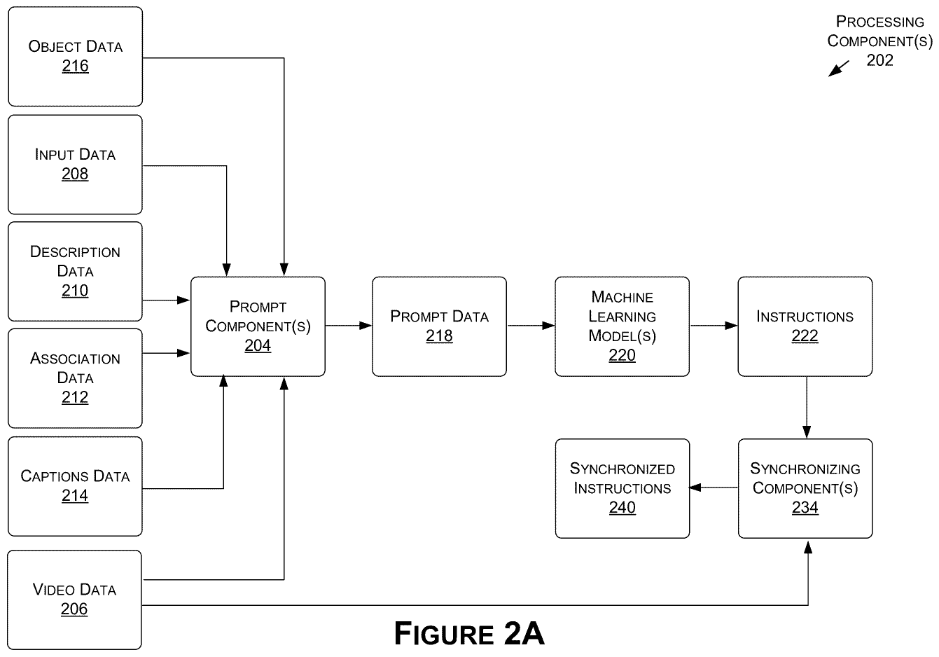

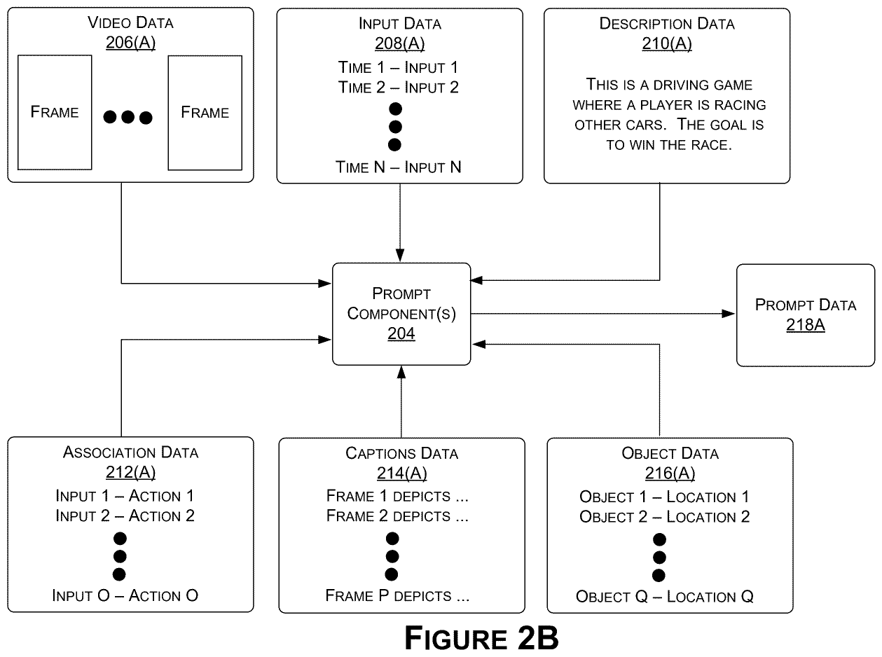

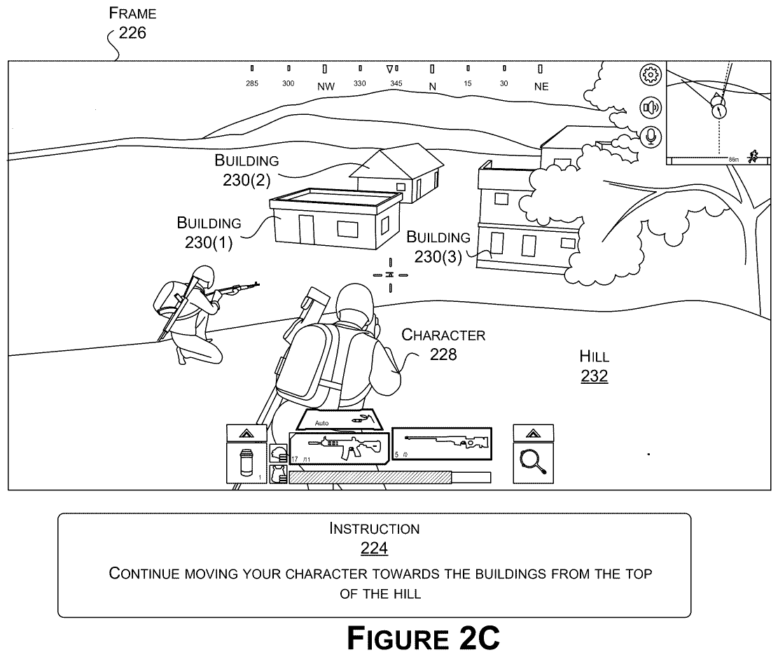

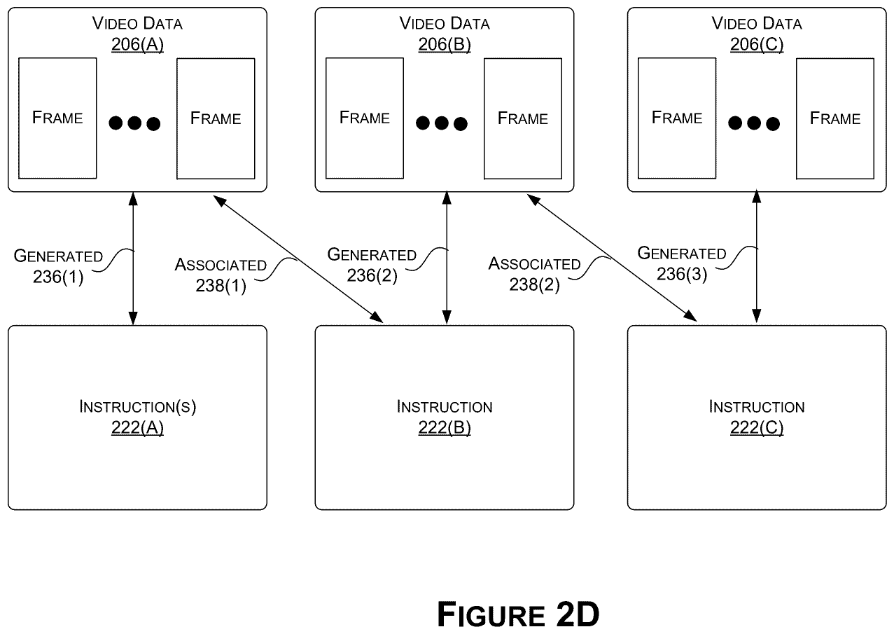

For more details, FIG. 2A illustrates an example of a first process for generating additional training data associated with one or more applications, in accordance with some embodiments of the present disclosure. In the example of FIG. 2A, one or more processing components 202 (which may include, and/or be similar to, the processing component(s) 114) may use a processing pipeline to generate the additional training data. In some examples, the processing component(s) 202 may be used when the training data is retrieved from one or more specific sources, such as an application service (e.g., a cloud gaming service), and/or when the training data includes specific types of data, such as video data and input data.

For instance, one or more prompt components 204 may receive data associated with an instance of training data, such as video data 206 (which may include, and/or be similar to, the video data 108) and input data 208 (which may include, and/or be similar to, the input data 110). Additionally, the prompt component(s) 204 may receive additional data (e.g., the application data 116), such as description data 210 describing an application, association data 212 representing associations between different inputs and actions, captions data 214 representing descriptions of frames associated with the video, and object data 216 representing information associated with objects depicted by the frames. The prompt component(s) 204 may then process the input data and, based at least on the processing, generate prompt data 218 representing a prompt associated with the instance of the training data.

FIG. 2B illustrates an example of generating a prompt associated with an instance of training data, in accordance with some embodiments of the present disclosure. As shown, video data 206(A) (which may include an instance of the video data 206) may represent one or more frames (e.g., a set of frames) associated with a video. In some examples, the video may be associated with a specific number of frames, such as 30 frames (and/or any other number of frames), and/or a specific duration of time, such as 10 seconds (and/or any other duration of time). The input data 208(A) (which may include an instance of the input data 208) may represent inputs and/or actions that occurred at different time intervals associated with the video. In some examples, an input may be associated with an input device, such as a key, a control, a button, a switch, a joystick movement, a portion of a touch-sensitive display, user speech, a signal, and/or any other type of input. For example, if the application includes a racing application, then a first input may be associated with pressing a first input, a second input may be associated with pressing a second input, and/or so forth.

The description data 210(A) (which may include an instance of the description data 210) may represent a description of the application. For instance, in the example of FIG. 2B, the application may include a racing application, such that the description describes at least the type of application (e.g., a racing game) and the goal of the application (e.g., to win the race). However, in other examples, the description may include additional and/or alternative information associated with the application. The association data 212(A) (which may include an instance of the association data 212) may represent associations between inputs and actions. For instance, the association data 212(A) may associate a first input (e.g., a first button) with a first action (e.g., turning left), a second input (e.g., a second button) with a second action (e.g., turning left), and/or so forth.

The captions data 214(A) (which may include an instance of the captions data 214) may represent captions associated with the frames. As described herein, a caption associated with a frame may describe objects depicted by the frame, a scene depicted by the frame, events that are occurring with regard to the frame, and/or any other information associated with the frame. For example, the captions may be generated using one or more models that process the frames, such as one or more vision-language models. Finally, the object data 216(A) (which may include an instance of the object data 216) may represent information—such as location information—associated with the objects. For instance, in some examples, the object data 216(A) may represent coordinates (e.g., the x-coordinate locations, the y-coordinate locations, etc.) of the objects as depicted by the frames, bounding shapes (e.g., bounding boxes) representing the locations of the objects as depicted by the frames, and/or any other location information. Additionally, in some examples, the object data 216(A) may represent additional information, such as classifications of the objects (e.g., person, vehicle, animal, structure, etc.).

As shown, the prompt component(s) 204 may process the video data 206(A), the input data 208(A), the description data 210(A), the association data 212(A), the captions data 214(A), and/or the object data 216(A). Based at least on the processing, the prompt component(s) 204 may generate and/or output prompt data 218(A) (which may include an instance of the prompt data 218) associated with the instance of the training data. In some examples, the prompt may include additional information, such as a task that is to be performed (e.g., generating instructions, which is described in more detail herein) and/or parameters associated with performing the task. For example, if the task is to generate an instruction, then the parameters may include what information to include with regard to the instruction, a length of the instruction, actions (e.g., maintaining a speed when driving straight, reducing a speed when turning, and/or the like for a racing game) that should be maintained with regard to the instruction, and/or any other parameter.

Referring back to the example of FIG. 2A, one or more machine learning models 220 may process the prompt data 218 and generate instructions 222 associated with the instances of training data. As described herein, the machine learning model(s) 220 may include one or more language models—such as one or more vision-language models—and/or any other type of model that is configured to perform one or more of the processes described herein. Additionally, in some examples, an instruction 222 may represent one or more actions that are occurring with regard to an application. For a first example, if an application includes a racing application, then an instruction 222 may be to turn a vehicle right, turn a vehicle left, decelerate, and/or any other driving action. For a second example, if an application includes a gaming application that involves moving a character within an environment, then an instruction 222 may include move forward, turn left, turn right, pick an item up, enter a structure, talk to another character, and/or any other action that may be performed with regard to the character.

For instance, FIG. 2C illustrates an example of an instruction 224 associated with a frame 226 of a gaming application, in accordance with some embodiments of the present disclosure. As shown, the frame 226 (along with one or more additional frames) may depict a character 228 approaching buildings 230(1)-(3) from a top of a hill 232 with another character. As such, the instruction 224 may describe one or more actions that are occurring with regard to the frame 226, such as the character 228 continuing to move towards the buildings 230(1)-(3) from the top of hill 232. However, in other examples, an instruction may describe any other action and/or information associated with the frame 226.

Referring back to the example of FIG. 2A, the process 100 may then include one or more synchronization components 234 synchronizing the instructions 222 with the frames represented by the video data 206. For instance, since the machine learning model(s) 220 generates the instructions 222 to describe actions that are currently occurring with respect to sets of frames, then the synchronization component(s) 234 may associate the instructions 222 with preceding sets of frames when generating the training data. This is because, in some examples, the VLA model(s) 102 is trained to generate instructions that should be performed next with regard to applications. As such, the VLA model(s) 102 should generate the instructions before the actions actually occur with regard to the application, which is described in more detail with regard to the training of the VLA model(s) 102.

For instance, FIG. 2D illustrates an example of synchronizing instructions with sets of frames, in accordance with some embodiments of the present disclosure. As shown, the machine learning model(s) 220 may initially generate a first instruction 222(A) for a first set of frames represented by the video data 206(A), a second instruction 222(B) for a second set of frames represented by video data 206(B), and a third instruction 222(C) for a third set of frames represented by video data 206(C), which is respectively represented by indications 236(1)-(3). Next, the synchronization component(s) 234 may associate at least the second instruction 222(B) with the first set of frames and the third instruction 222(C) with the second set of frames, which is respectively represented by indications 238(1)-(2). This is because, in some examples, the VLA model(s) 102 is then trained to predict the instructions for actions that should occur with regard to the application. For example, when processing input data that includes at least the video data 206(A) (and/or the first instruction 222(A)), the VLA model(s) 102 is trained to generate output data representing the second instruction 222(B).

Referring back to the example of FIG. 2A, the output from the processing component(s) 202 may include the instructions 222 synchronized with the video data 206, which is represented by the synchronized instructions 240. For instance, the synchronized instructions 240 may include at least a portion of the additional training data 118 from the example of FIG. 1. This way, the processing component(s) 202 may use the initial training data that includes at least the video data 206 and the input data 208 to then generate the additional training data that includes the corresponding instructions. While the examples of FIGS. 2A-2D describe using the processing component(s) 202 to generate the instructions 222, in other examples, similar processes may be used to generate other types of text associated with the application. For example, similar processes may be used to generate text describing information associated with the application, text describing information associated with the frames, and/or the like.

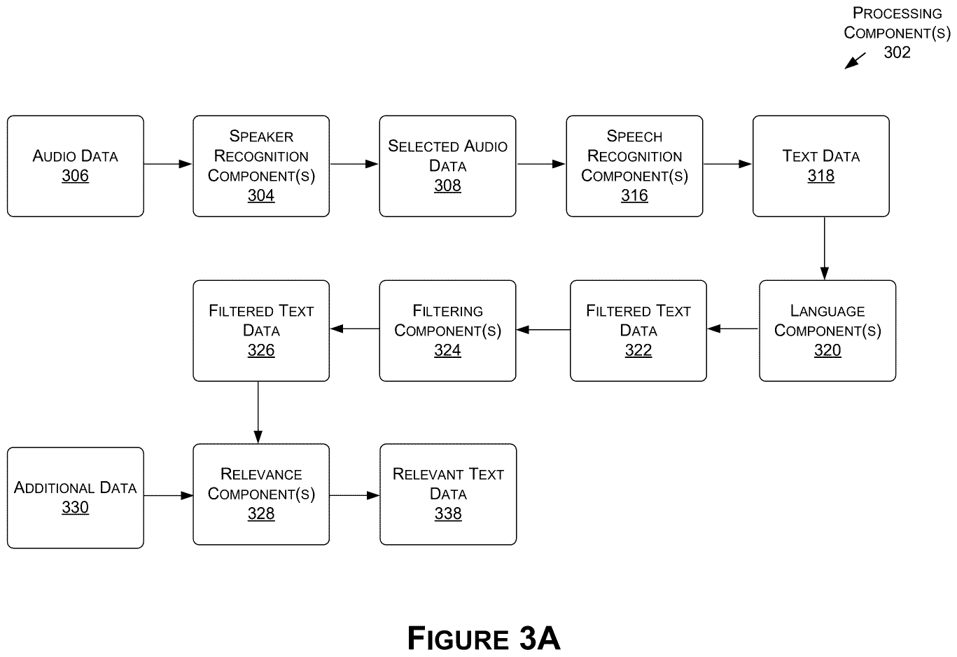

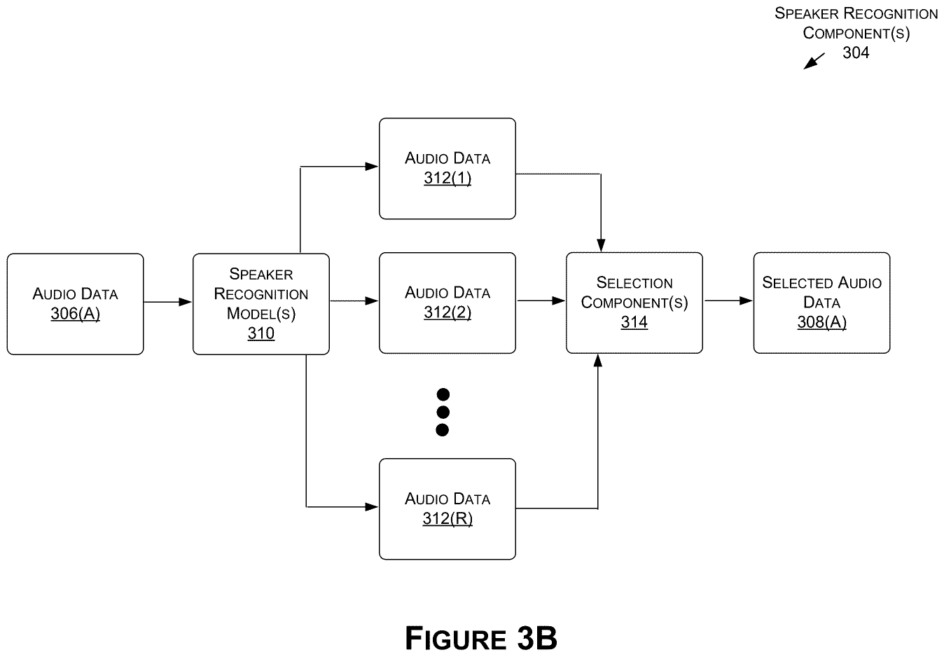

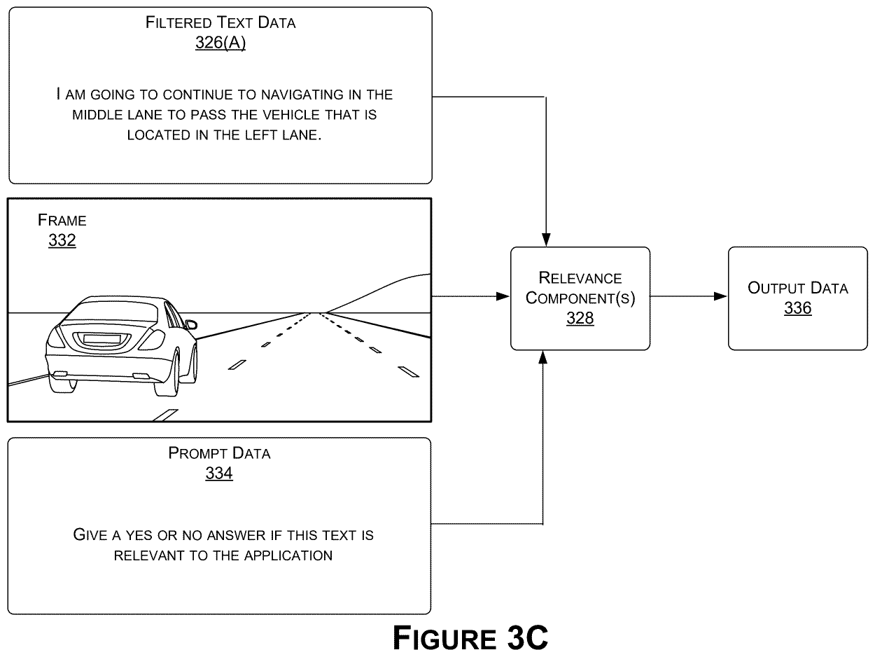

FIG. 3A illustrates an example of a second process for generating additional training data associated with one or more applications, in accordance with some embodiments of the present disclosure. In the example of FIG. 3A, one or more processing components 302 (which may include, and/or be similar to, the processing component(s) 114) may use a processing pipeline to generate the additional training data. In some examples, the processing component(s) 302 may be used when the training data is retrieved from one or more specific sources, such as a content sharing service, or when the training data includes specific types of data, such as video data and audio data.

For instance, one or more speaker recognition components 304 may process audio data 306 (which may include, and/or be similar to, the audio data 112) representing user speech associated with videos of applications. As described herein, the speaker recognition component(s) 304 may include and/or use one or more machine learning models—such as one or more speaker recognition models—to identify user speech that is associated with users. The speaker recognition component(s) 304 may then determine a portion of the audio data 306 that represents user speech associated with primary users of the applications. In some examples, the speaker recognition component(s) 304 may determine that user speech is associated with a primary user based at least on a majority of the user speech being associated with that user. However, in other examples, the speaker recognition component(s) 304 may use any other technique determine the user speech that is associated with the primary users. The speaker recognition component(s) 304 may then output selected audio data 308 representing the user speech that is associated with the primary users.

For instance, FIG. 3B illustrates an example of determining user speech that is associated with a primary user, in accordance with some embodiments of the present disclosure. As shown, the speaker recognition component(s) 304 may use one or more speaker recognition models 310 to process audio data 306(A) (which may represent an instance of the audio data 306) representing user speech associated with a video. The speaker recognition model(s) 310 may then determine a first portion 312(1) of the audio data 306(A) represents first user speech from a first user, a second portion 312(2) of the audio data 306(A) represents second user speech from a second user, and/or so forth until a final portion 312(R) of the audio data 306(A) represents final speech from a final user. The speaker recognition component(s) 304 may then use one or more selection components 314 to select the portion 312(1)-(R) of the audio data 306(A) that is associated with the primary user. For instance, in the example of FIG. 3B, the selection component(s) 314 may determine that the first portion 312(1) of the audio data 306(A) is associated with the primary user based at least on the first user speech including a majority of the user speech associated with the video. As such, the speaker recognition component(s) 304 may select the first portion 312(1) of the audio data 306(A) to include as selected audio data 308(A) (which may represent an instance of the selected audio data 308). Additionally, the speaker recognition component(s) 304 may perform similar processes for one or more additional instances of audio data 306 associated with one or more additional videos.

Referring back to the example of FIG. 3A, the processing component(s) 302 may use one or more speech recognition components 316 to process the selected audio data 308 and generate text data 318 representing text associated with the user speech. As described herein, the speech recognition component(s) 316 may include and/or use one or more automatic speech recognition models, one or more natural language models, one or more speech-to-text models, and/or any other type of processing component to generate the text data 318. Additionally, the text represented by the text data 318 may include letters, words, sentences, numbers, characters, symbols, and/or any other type of text. For example, the text may include transcripts associated with the user speech.

The processing component(s) 302 may further include one or more language components 320 that process the text data 318 to identify at least a portion of the text that is associated with one or more specific languages. As described herein, the language component(s) 320 may use one or more machine learning models—such as one or more language models (and/or any other type of model)—and/or any other type of processing component that is configured to perform one or more of the processes described herein. For example, if the text data 318 represents text associated with multiple languages, such as English, Spanish, Chinese, and/or the like, then the language component(s) 320 may select the text that is associated with the specific language(s), such as English and Chinese. The output from the language component(s) 320 may then include filtered text data 322 representing the text in the specific language(s).

The processing component(s) 302 may also include one or more filtering components 324 that process the filtered text data 322 to remove at least a portion of the text that is associated with selected words. As described herein, the filtering component(s) 324 may use one or more machine learning models—such as one or more language models (and/or any other type of model)—and/or any other type of processing component that is configured to perform one or more of the processes described herein. Additionally, in some examples, the selected words removed by the filtering component(s) 324 may include inappropriate words, such as profane, abusive, derogatory, taunting, harassing, and/or other types of inappropriate language. However, in other examples, the selected words removed by the filtering component(s) 324 may include other types of language.

The filtering component(s) 324 may use any technique to identify and/or remove the selected words from the text. For a first example, the filtering component(s) 324 may generate, receive, retrieve, obtain, and/or use a list of words—such as in the form of a dictionary and/or other type of document—that includes the selected words (to remove. The filtering component(s) 324 may then compare the text to the list of words in order to identify one or more words from the text that are included in the list of words. Additionally, the filtering component(s) 324 may then remove at least those words from the text (and/or the transcripts that include those words). For a second example, the filtering component(s) 324 may use one or more machine learning models that are trained to process the text to determine whether the text includes the selected words. The filtering component(s) 324 may then remove the text that includes the selected words (and/or the transcripts that include those words) as identified by the machine learning model(s). While these are just a couple example techniques for how the filtering component(s) 324 may filter the text, in other examples, the filtering component(s) 324 may use additional and/or alternative techniques. As shown, the output from the filtering component(s) 324 may then include filtered text data 326 representing the text, in the specific language(s), and filtered to remove the specific words.

The processing component(s) 302 may then include one or more relevance components 328 that process the filtered text data 326 and/or additional data 330 to determine whether the text (e.g., the filtered text) is relevant to the videos and/or the application. As described herein, the relevance component(s) 328 may use one or more machine learning models—such as one or more language models, one or more vision-language models, and/or any other type of model—and/or any other type of processing component that is configured to perform one or more of the processes described herein. Additionally, the additional data may represent the video data representing of the videos (e.g., the video data 108), descriptions of the applications (e.g., similar to the description data 210), captions associated with the frames (e.g., similar to the captions data 214), a prompt to identify the relevant text, and/or any other data. Furthermore, text associated with a video may be relevant when the text describes the video (e.g., describes one or more actions being performed), describes an application associated with the video, and/or using any other criteria.

For instance, FIG. 3C illustrates an example of determining whether text is relevant to a video, in accordance with some embodiments of the present disclosure. As shown, the relevance component(s) 328 may process at least filtered text data 326(A) (which may represent an instance of the filtered text data 326) representing text, video data representing at least a frame 332 associated with the text, and prompt data 334 representing a prompt associated with identifying relevant text. For instance, the prompt is asking for a yes or no answer to whether the text is relevant to the frame 332. However, in other examples, the prompt may include any other type of instructions associated with determining whether the text is relevant to the frame 332. For example, the prompt may just include text asking, “Is this text relevant to the video.”

In the example of FIG. 3C, the relevance component(s) 328 may generate and/or output data 336 representing whether the text is relevant to the video. For a first example, the output data 336 may represent an indication that the text is relevant to the video or an indication that the text is not relevant to the video. For instance, since the text is relevant to the video in the example of FIG. 3C, the output data 336 may just represent an indication that the text is relevant to the video. For a second example, the output data 336 may represent a first probability that the text is relevant to the video and a second probability that the text is not relevant to the video. In such an example, the relevance component(s) 328 may then use the probabilities to determine whether the text is relevant to the video. For instance, since the text is again relevant to the video in the example of FIG. 3C, the relevance component(s) 328 may determine that the text is relevant to the video based at least on the first probability being greater than the second probability and/or the first probability satisfying (e.g., being equal to or greater than) a threshold probability. While these examples describe two types of outputs that may be generated by the relevance component(s) 328, in other examples, the relevance component(s) 328 may generate and/or output other types of outputs indicating whether the text is relevant to the video.

Referring back to the example of FIG. 3A, the processing component(s) 302 may generate and/or output relevant text data 338 representing the instances of text (e.g., the transcripts) that are relevant to the videos. For instance, the relevant text data 338 may include at least a portion of the additional training data 118 from the example of FIG. 1.

Referring back to the example of FIG. 1, the process 100 may include generating one or more training datasets 120 for training the VLA model(s) 102. For instance, the training dataset(s) 120 may include at least a portion of the training data 104 and/or at least a portion of the additional training data 118. This way, the training dataset(s) 120 may include at least the video data 108 representing the videos, the input data 110 representing the inputs received and/or the actions performed with respect to the videos, and the additional training data 118 representing at least the text (e.g., the instructions, the descriptions, etc.) associated with the videos. The process 100 may then include using one or more training components 122 to train the VLA model(s) 102 using the training dataset(s) 120.

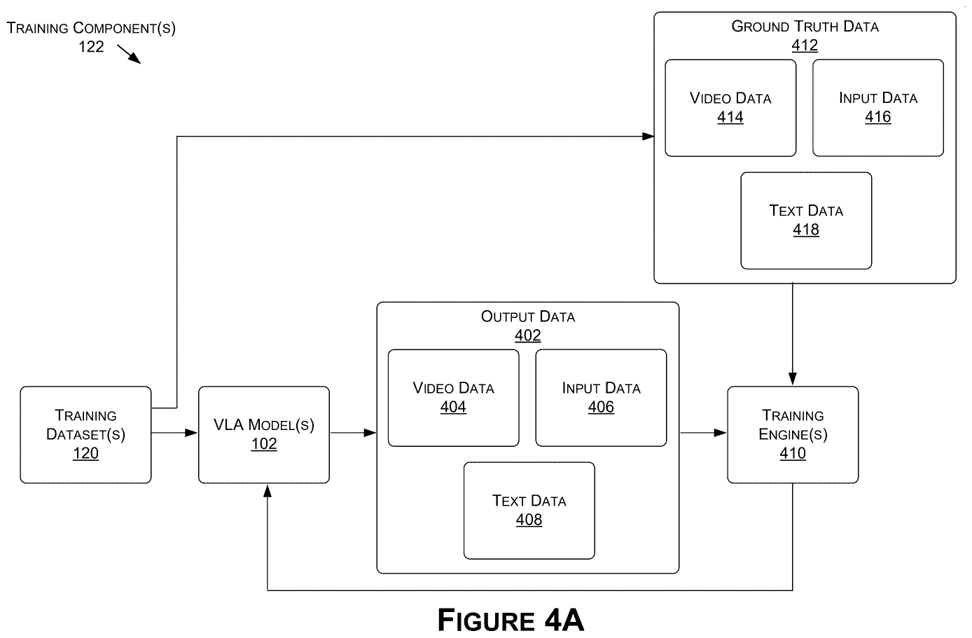

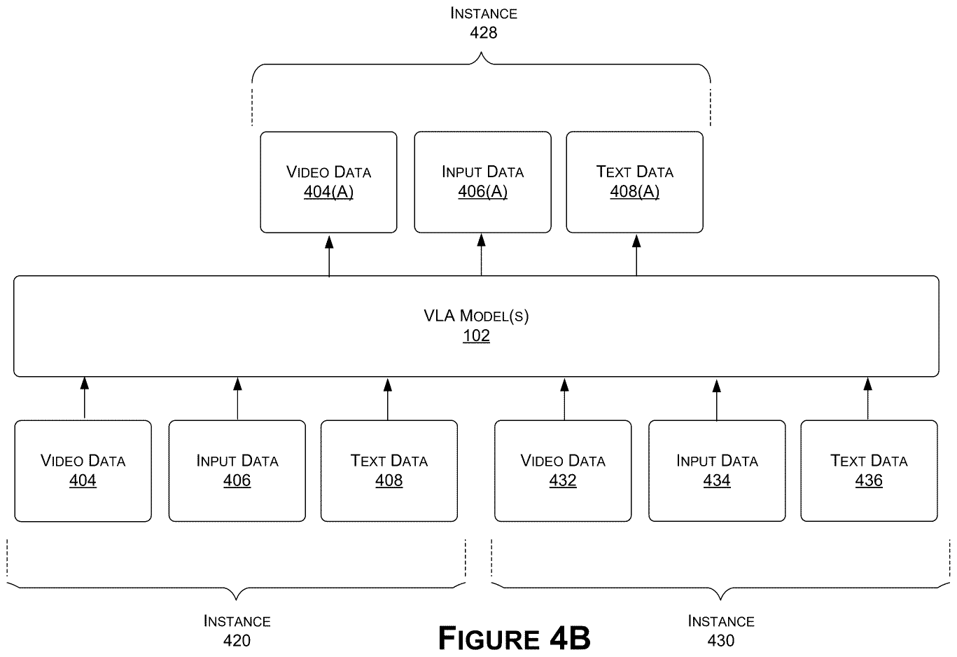

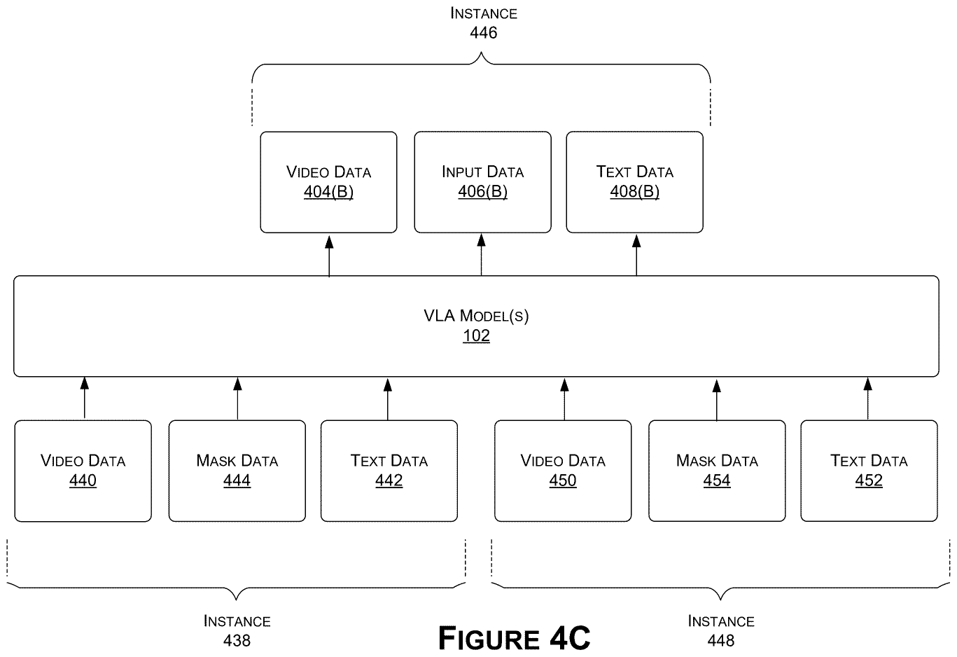

For instance, FIG. 4A illustrates a data flow diagram illustrating a process for training the VLA model(s) 102 to provide information associated with applications, in accordance with some embodiments of the present disclosure. As shown, the training component(s) 122 may train the VLA model(s) 102 using the training data from the training dataset(s) 120. For example, the training component(s) 122 may input, into the VLA model(s) 102, the video data representing the videos, the input data representing the inputs and/or actions, and/or the text data representing the text (e.g., the instructions). Based at least on processing the data, the VLA model(s) 102 may generate and/or output data 402 representing predicted video data 404, predicted input data 406, and/or predicted text data 408.

One or more training engines 410 may then use one or more loss functions that measure loss (e.g., error) in outputs 402 as compared to ground truth data 412 that also includes video data 414, input data 416, and/or text data 418. In some examples, different outputs 402 may have different loss functions. For example, the predicted video data 404 may be associated with a first loss function, the predicted input data 406 may be associated with a second loss function, and/or the predicted text data 408 may be associated with a third loss function. In such examples, the loss functions may be combined to form a total loss, and the total loss may be used to train (e.g., update the parameters and/or weights of) the VLA model(s) 102. In any example, backward pass computations may be performed to recursively compute gradients of the loss function(s) with respect to training parameters. In some examples, weights and biases of the VLA model(s) 102 may be used to compute these gradients.

For more details, FIG. 4B illustrates an example of measuring loss associated training the VLA model(s) 102, in accordance with some embodiments of the present disclosure. As shown, the training component(s) 122 may input, into the VLA model(s) 102, a first instance 420 of training data that includes video data 422, input data 424, and text data 426. The VLA model(s) 102 may then process the first instance 420 of training data and generate an instance 428 of output data that includes predicted video data 404(A), predicted input data 406(A), and predicted text data 408(A). The training engine(s) 410 may then compare the instance 428 of output data to a second instance 430 of training data that includes video data 432, input data 434, and text data 436. This is because the second instance 430 of training data may occur after the first instance 420 of training data with regard to the application. As such, the instance 428 of output data may attempt to predict the second instance 430 of training data.

For instance, the training engine(s) 410 may determine a first loss based at least on comparing the predicted video data 404(A) to the video data 432, a second loss based at least on comparing the predicted input data 406(A) to the input data 434, and/or a third loss based at least on comparing the predicted text data 408(A) to the text data 436. The training engine(s) 410 may then use one or more of the losses to train the VLA model(s) 102, such as by updating one or more parameters and/or weights associated with the VLA model(s) 102. This process may then continue to repeat as new instances of training data are input into the VLA model(s) 102 and new instances of output data are generated by the VLA model(s) 102. While the example of FIG. 4B illustrates training the VLA model(s) 102 to predict video data, input data, and text data, in other examples, the VLA model(s) 102 may be trained to predict one or more of the video data, the input data, and/or the text data. For example, the VLA model(s) 102 may be trained to just predict the text data representing instructions and/or the input data representing inputs for performing actions associated with the instructions.

FIG. 4C illustrates another example of measuring loss associated training the VLA model(s) 102, in accordance with some embodiments of the present disclosure. For instance, as described herein, in some examples, instances of training data may not include specific types of data, such as input data representing the inputs that were received and/or the actions that were performed. As such, the training component(s) 122 may need to perform one or more other processes when training the VLA model(s) 102 using such data.

For instance, and as shown, the training component(s) 122 may input, into the VLA model(s) 102, a first instance 438 of training data that includes video data 440 and text data 442. However, since there is no input data associated with the first instance 438 of training data, the training component(s) 122 may further input mask data 444 representing a mask associated with the input data. The VLA model(s) 102 may then again process the first instance 438 of training data and generate an instance 446 of output data that includes predicted video data 404(B), predicted input data 406(B), and predicted text data 408(B). The training engine(s) 410 may then compare the instance 446 of output data to a second instance 448 of training data that includes video data 450, text data 452, and additional mask data 454 associated with input data.

For instance, the training engine(s) 410 may determine a first loss based at least on comparing the predicted video data 404(B) to the video data 450 and/or a second loss based at least on comparing the predicted text data 408(B) to the text data 452. The training engine(s) 410 may then use one or more of the losses to train the VLA model(s) 102, such as by updating one or more parameters and/or weights associated with the VLA model(s) 102. This process may then continue to repeat as new instances of training data are input into the VLA model(s) 102 and new instances of output data are generated by the VLA model(s) 102. While the example of FIG. 4C illustrates training the VLA model(s) 102 to predict video data and text data, in other examples, the VLA model(s) 102 may be trained to predict one or more of the video data and/or the text data. Additionally, while the example of FIG. 4C illustrates masking the input data, in other examples, similar processes may be used to mask the video data and/or the text data when training the VLA model(s) 102.

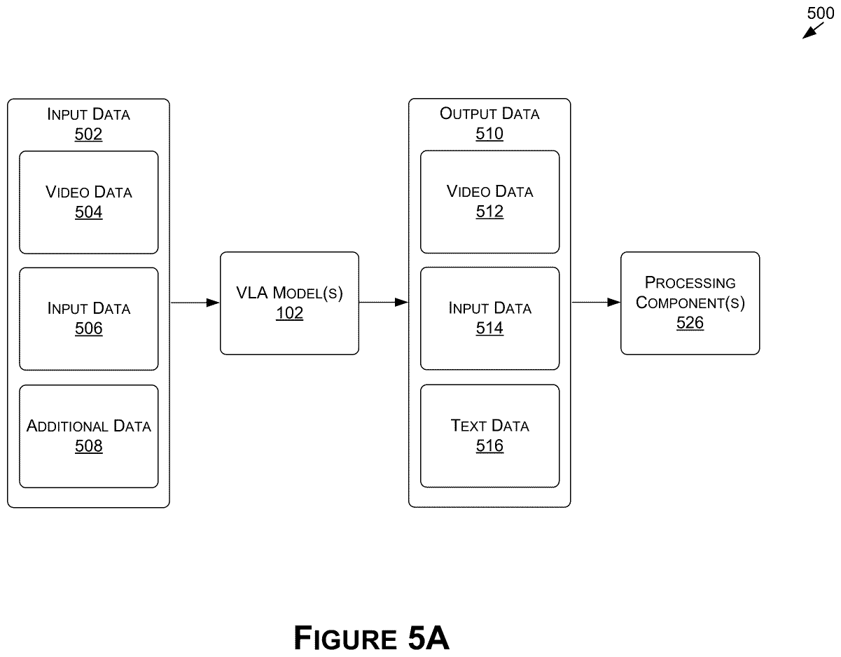

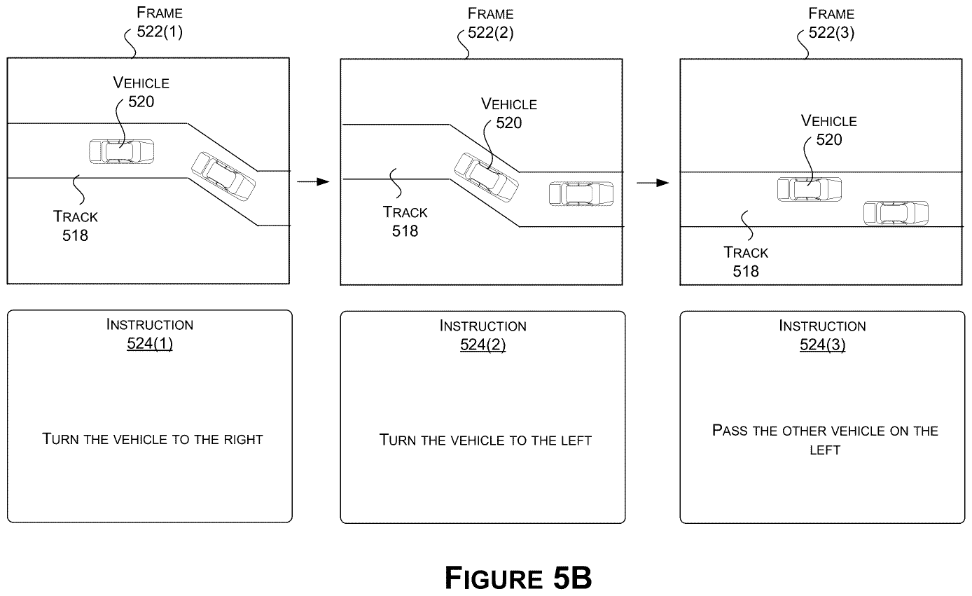

As described herein, after training the VLA model(s) 102, the VLA model(s) 102 may be used to perform one or more operations. For instance, FIG. 5A illustrates an example of a process 500 of using the VLA model(s) 102 to provide information associated with an application, in accordance with some embodiments of the present disclosure.

As shown, the process 500 may include applying input data 502 to the VLA model(s) 102. As described herein, the input data 502 may include, but is not limited to, video data 504, input data 506, and/or additional data 508. The video data 504 may represent frames associated with an application, such as an interactive application being utilized by one or more users. In some examples, the video data 504 may represent sets of frames applied to the VLA model(s) 102 at given time instances, where a set of frames may include any number of frames. Additionally, or alternatively, in some examples, the video data 504 may represent frames that are continuously applied to the VLA model(s) 102. For example, the frames may be applied to the VLA model(s) 102 as the frames are being generated using one or more systems.

The input data 506 may represent inputs associated with the video data 504, such as inputs being received by one or more user devices when presenting the frames, and/or actions that were performed with regard to the inputs. Similar to the video data 504, in some examples, the input data 506 may represent sets of inputs applied to the VLA model(s) 102 at given time instances, where a set of inputs may include any number of inputs. Additionally, or alternatively, in some examples, the input data 506 may represent inputs that are continuously applied to the VLA model(S) 102. For example, the input data 506 representing the inputs may be applied as the inputs are being received by one or more systems. In any example, the input data 506 may be associated with the video data 504, such as by using timestamps that associate the inputs with the frames that were presented when receiving the inputs and/or the frames that represent the actions performed based at least on the inputs.

In some examples, the additional data 508 may include application data, such as similar to the description data 210, the association data 212, the captions data 214, and/or the object data 216. In some examples, the additional data 508 may include prompt data representing a prompt to generate a specific type of output, such as instructions, and/or any other type of data. Still, in some examples, the additional data 508 may include input data from one or more users, such as input data representing actions to perform with regard to the application. For example, the input data may represent a task that the user wants performed with regard to the application, such as to generate instructions to be performed with regard to the application.

The process 500 may then include the VLA model(s) 102 processing the input data 502 and, based at least on the processing, generating and/or outputting data 510 representing information associated with the application. As shown, in some examples, the output data 510 may include video data 512, input data 514, and/or text data 516. As described herein, in some examples, the output data 510 may be associated with one or more previous states associated with the application, a current state associated with the application, and/or one or more future states associated with the application. For instance, the text data 516 may represent text associated with the application, such as instructions that were previous performed with regard to the application, an instruction that is currently being performed by the application, and/or future instructions that should be performed with regard to the application. For a first example, if the input data 502 is associated with a set of frames, then the text data 516 may represent an instruction for a next action that should be taken with regard to the application. For a second example, if the input data 502 is again associated with a set of frames, then the text data 516 may represent a previous instruction associated with a previous action that occurred with regard to the set of frames. Still, for a third example, if the input data 502 is again associated with a set of frames, then the text data 516 may represent a current instruction associated with a current actin that is occurring.

Additionally, the input data 514 may represent inputs and/or actions associated with performing the previous instructions, the current instruction, and/or the future instructions. For a first example, if an instruction for a driving application is to turn a vehicle left, then the input data 514 may represent one or more inputs to apply to cause the vehicle to turn left. For a second example, if a previous instruction for a driving application described a vehicle turning left, then the input data 514 may represent one or more inputs that were applied that caused the vehicle to turn left. Still, for a third example, if a current instruction for driving application describes a vehicle as turning left, then the input data 514 may represent one or more inputs that are being applied to cause the vehicle to turn left.

The video data 512 may represent frames depicting the previous instructions being performed with regard to the application, the current instruction being performed with regard to the application, and/or the future instructions being performed with regard to the application. For a first example, if a future instruction for a driving application is to turn a vehicle left, then the video data 512 may represent one or more frames depicting the vehicle turning left. In other words, the video data 512 may represent frames depicting actions occurring that are associated with the instructions. For a second example, if a previous instruction for a driving application was turning a vehicle left, then the video data 512 may represent one or more frames depicting the vehicle as turning left based on the previous instruction. As such, the frame(s) may be similar to one or more frames already displayed for the application and/or one or more missing frames, such as one or more dropped frames.

For instance, FIG. 5B illustrates an example of providing instructions associated with an application, in accordance with some embodiments of the present disclosure. In the example of FIG. 5B, the application may include a racing application that provides a top-down view of a track 518, where the user is supposed to navigate a vehicle 520 along the track 518 that includes other vehicles. As such, at a first time instance, the VLA model(s) 102 may process at least video data representing a first frame 522(1) and generate a first instruction 524(1) that should be performed with regard to the racing application. For instance, since the vehicle 520 is approaching a right turn, the first instruction 524(1) may include causing the vehicle 520 to make a right turn.

Next, at a second time instance, the VLA model(s) 102 may process at least video data representing a second frame 522(2) and generate a second instruction 524(2) that should be performed with regard to the racing application. For instance, since the vehicle 520 is now approaching a left turn, the second instruction 524(2) may include causing the vehicle 520 to make a left turn. Next, and at a third time instance, the VLA model(s) 102 may process at least video data representing a third frame 522(3) and generate a third instruction 524(3) that should be performed with regard to the racing application. For instance, since the vehicle 520 is now on a straight portion of the track 518, the third instruction 524(3) may include causing the vehicle 520 to pass another vehicle. This process may then continue to repeat as additional frames associated with the racing application are generated.

While the example of FIG. 5B illustrates the VLA model(s) 102 as generating instructions 524(1)-(3) associated with the driving application, in other examples, the VLA model(s) 102 may generate other types of data associated with the driving application. For a first example, and with regard to the first frame 522(1), the VLA model(s) 102 may generate input data representing one or more inputs for performing the first instruction 524(1), such as one or more input devices that should be utilized and/or an order associated with utilizing the input device(s) (e.g., press a first button, followed by a second button, followed by a third button, etc.). For a second example, and again with regard to the first frame 522(1), the VLA model(s) 102 may generate video data representing at least a prediction of the second frame 522(2) that depicts the vehicle 520 performing the first instruction 524(1).

Additionally, while the example of FIG. 5B describes generating the future instructions 524(1)-(3) associated with the driving application, in other examples, the VLA model(s) 102 may generate previous and/or current instructions associated with the driving application. For example, the VLA model(s) 102 may process video data representing the frames 522(1)-(3). Based at least on processing the video data, the VLA model(s) 102 may then generate data representing the first instruction 524(1) and/or the second instruction 524(2). In other words, the VLA model(s) 102 may determine the instructions 524(1)-(2) that occurred to cause the actions associated with the frames 522(1)-(3).

Referring back to the example of FIG. 5A, the process 500 may include one or more processing components 526 performing one or more operations using the output data 510. As described herein, in some examples, an operation may include presenting content associated with the output data 510, such as the frames represented by the video data 512, the inputs represented by the input data 514, and/or the text (e.g., the instructions) represented by the text data 516. In some examples, an operation may be associated with performing one or more actions corresponding to the text, such as by causing an instruction to occur. For example, and using the example of FIG. 5B, an operation associated with the first instruction 524(1) may include applying one or more inputs associated with the first instruction 524(1) to the application in order to cause the vehicle 520 to turn right. While these are just a few examples of operations that may be performed by the processing component(s) 526, in other examples, the processing component(s) 528 may perform additional and/or alternative operations.

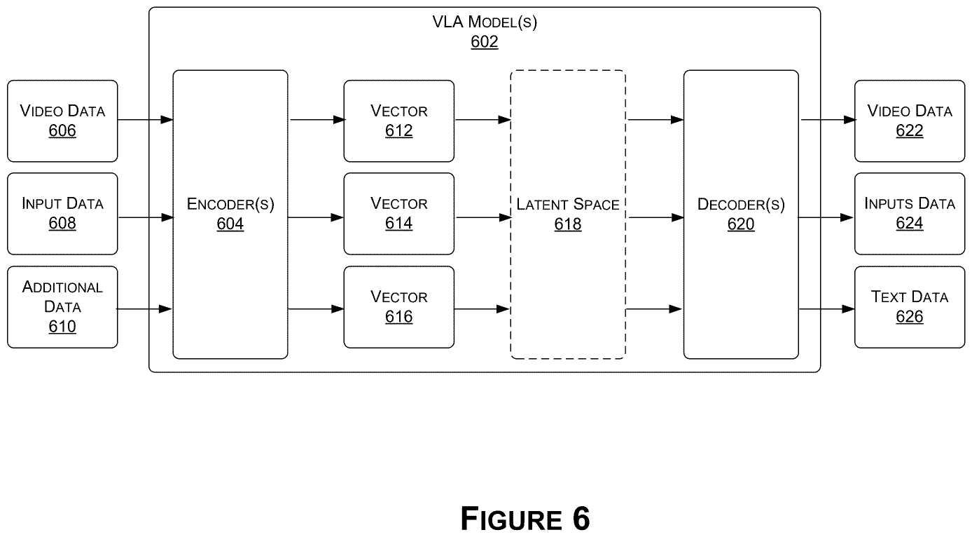

As described herein, the VLA model(s) 102 may include a multi-modal model that is configured to process various types of inputs, such as video data, input data, and/or text data. As such, FIG. 6 illustrates an example of one or more machine learning models 602 processing data to generate outputs, in accordance with some embodiments of the present disclosure. In some examples, the model(s) 602 may also be referred to as a VLA model(s) 602 and/or include or be similar to the VLA model(s) 102.

As shown, the VLA model(s) 602 may include one or more encoders 604 that are configured to process video data 606, input data 608, and/or text data 610. For example, the VLA model(s) 602 may include a first encoder 604 to process the video data 606 and generate first vectors 612 associated with frames, a second encoder 604 to process the input data 608 and generate second vectors 614 associated with inputs and/or actions, and a third encoder 604 to process the text data 610 and generate third vectors 616 associated with the text. In some examples, since the vectors 612-616 may initially include different dimensions based on the different modalities, the vectors 612-616 may be transformed to include similar dimensions.

As further shown, the vectors 612-616 may be transformed and/or mapped into a latent space 618. The VLA model(s) 602 may then include one or more decoders 620 that are configured to generate one or more of the outputs described herein. For example, the VLA model(s) 602 may include a first decoder 620 that is configured to generate video data 622 representing one or more frames, such as similar to the video data 512, a second decoder 620 that is configured to generate input data 624 representing one or more inputs and/or actions, such as similar to the input data 514, and/or a third decoder 620 that is configured to generate text data 626 representing text (e.g., instructions), such as similar to the text data 516. In some examples, the decoder(s) 620 may generate the outputs at different time intervals. For example, the decoder(s) 620 may generate outputs in an order that includes the video data 622, followed by the input data 624, and finally followed by the text data 626 (and/or any other order).

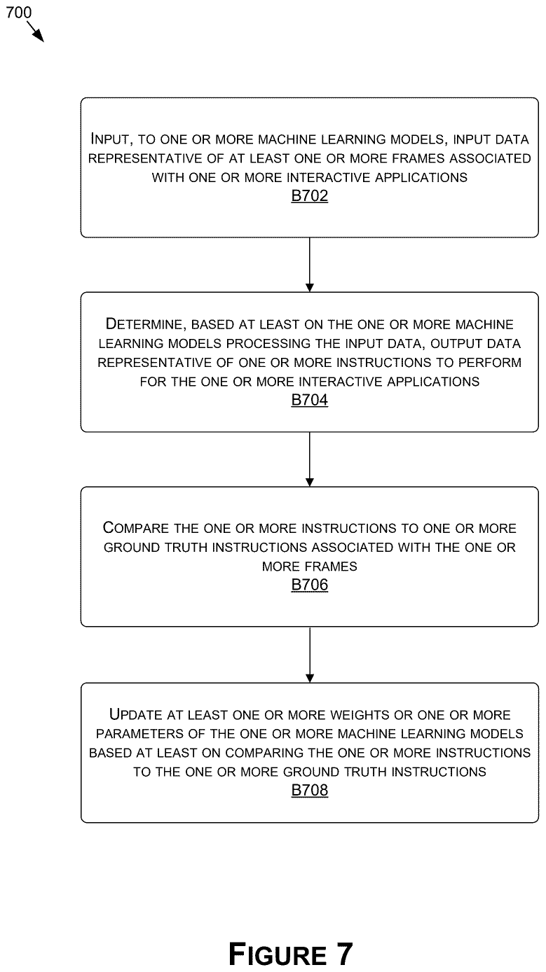

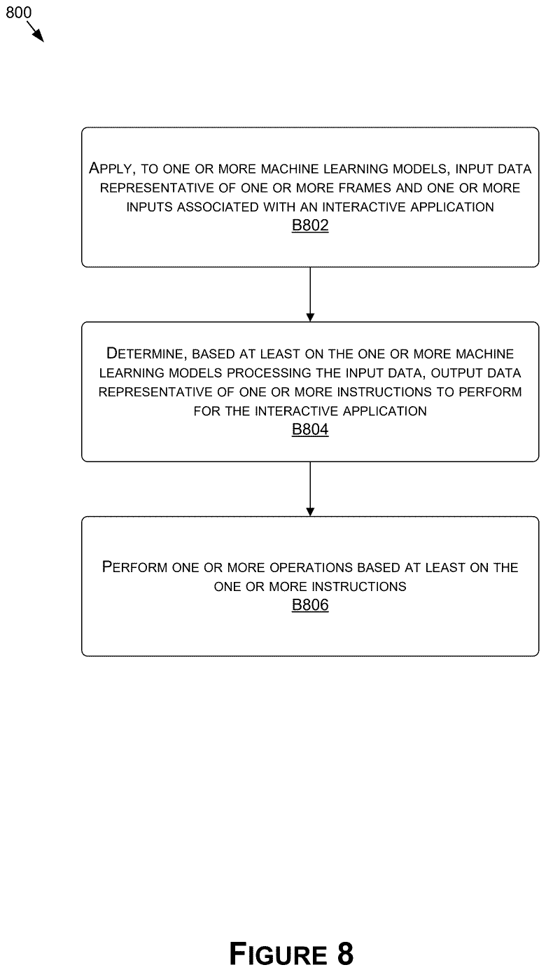

Now referring to FIGS. 7-8 each block of methods 700 and 800, described herein, comprises a computing process that may be performed using any combination of hardware, firmware, and/or software. For instance, various functions may be carried out by a processor executing instructions stored in memory. The methods 700 and 800 may also be embodied as computer-usable instructions stored on computer storage media. The methods 700 and 800 may be provided by a standalone application, a service or hosted service (standalone or in combination with another hosted service), or a plug-in to another product, to name a few. In addition, the methods 700 and 800 are described, by way of example, with respect to specific figures. However, these methods 700 and 800 may additionally or alternatively be executed by any one system, or any combination of systems, including, but not limited to, those described herein.

FIG. 7 illustrates a flow diagram showing a method 700 for training one or more machine learning models to generate information associated with applications, in accordance with some embodiments of the present disclosure. The method 700, at block B702, may include applying, to one or more machine learning models, input data representative of at least one or more frames associated with one or more interactive applications. For instance, the training input data from the training dataset(s) 120—such as the training data 104 and/or the additional training data 118—may be applied to the VLA model(s) 102. As described herein, the training input data may represent the video data 108, the input data 110, text data (e.g., the synchronized instructions 240, the relevant text data 338, etc.), and/or any other type of data.

The method 700, at block B704, may include determining, based at least on the one or more machine learning models processing the input data, output data representative of one or more instructions to perform for the one or more interactive applications. For instance, the VLA model(s) 102 may process the training input data and generate the output data 402. As described herein, in some examples, the output data 402 may include the text data 408 representing the instruction(s) to be performed with respect to the interactive application(s). Additionally, in some examples, the output data 402 may include the predicted video data 404, the predicted input data 406, and/or any other type of data for which the VLA model(s) 102 is being trained to generate.

The method 700, at block B706, may include comparing the one or more instructions to one or more ground truth instructions associated with the one or more frames. For instance, the training engine(s) 410 may compare the instruction(s) represented by the text data 408 to the ground truth instruction(s) represented by the text data 418. Based at least on the comparing, the training engine(s) 410 may determine one or more losses. Additionally, in some examples, the training engine(s) 410 may compare the predicted video data 404 to the video data 414 and/or the predicted input data 406 to the input data 416 to determine one or more additional losses.

The method 700, at block B708, may include updating at least one of one or more parameters or one or more weights of the one or more machine learning models based at least on comparing the one or more instructions to the one or more ground truth instructions. For instance, the training engine(s) 410 may update the weight(s) and/or the parameter(s) of the VLA model(s) 102 based at least on the loss(es). As such, by performing the method 700, the VLA model(s) 102 may be trained to generate instructions associated with the interactive application(s), predict frames associated with the interactive application(s), and/or determine inputs for performing the instruction(s).

FIG. 8 illustrates a flow diagram showing a method 800 for using one or more machine learning models to generate information associated with applications, in accordance with some embodiments of the present disclosure. The method 800, at block B802, may include applying, to one or more machine learning models, input data representative of one or more frames and one or more inputs associated with an interactive application. For instance, the input data 502 may be applied to the VLA model(s) 102. As described herein, the input data 502 may include at least the video data 504 representing the frame(s) and the input data 506 representing the input(s). Additionally, in some examples, the input data 502 may include the additional data 508, such as data representing a description of the application, one or more captions associated with the frame(s), associations between inputs and actions, information associated with one or more objects depicted by the frame(s), one or more tasks to perform, one or more prompts, and/or so forth.

The method 800, at block b804, may include determining, based at least on the one or more machine learning models processing the input data, output data representative of one or more instructions to perform with regard to the interactive application. For instance, the VLA model(s) 102 may process the input data 502 and generate the output data 510. As described herein, the output data 510 may include at least the text data 516 representing the text, such as the instruction(s) to perform with regard to the interactive application. Additionally, in some examples, the output data 510 may include the video data 512 representing one or more next frames associated with the interactive application, the input data 514 representing one or more inputs for performing the instruction(s), and/or any other type of data.

The method 800, at block B806, may include performing one or more operations based at least on the one or more instructions. For instance, the processing component(s) 528 may perform the operation(s) using at least the instruction(s). As describe herein, an operation may include, but is not limited to, presenting the instruction(s) to one or more users, causing one or more actions associated with the instruction(s) to occur, and/or any other type of operation.

### Example Language Models

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources - such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

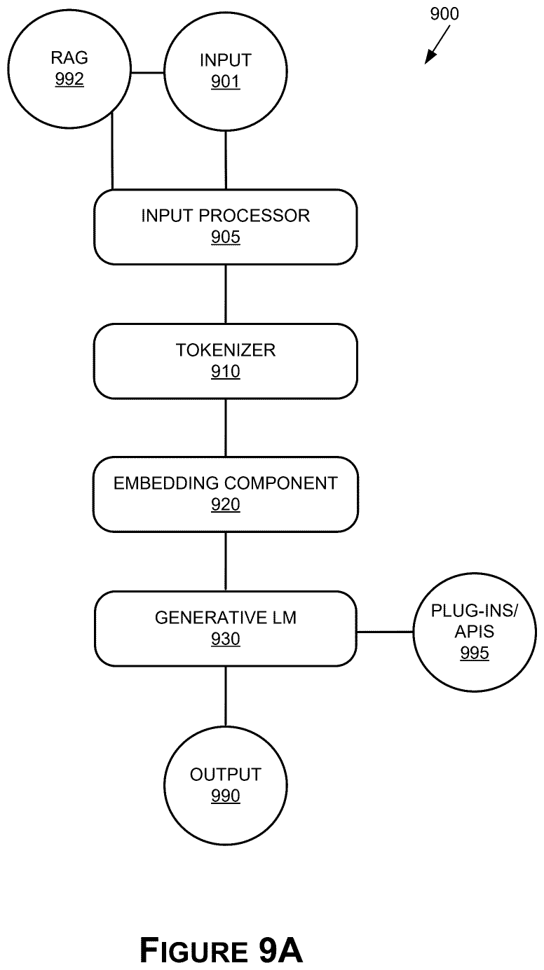

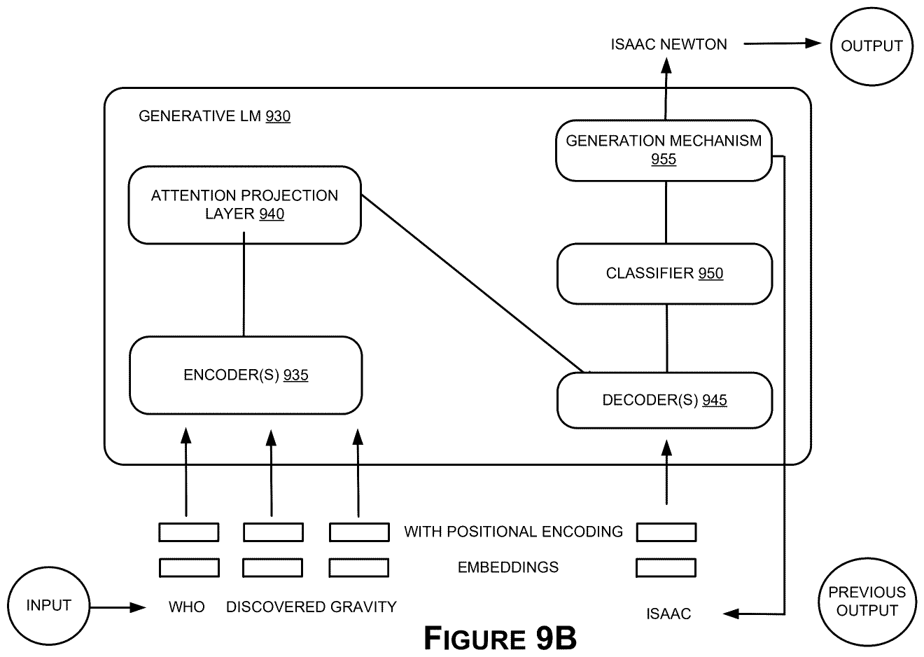

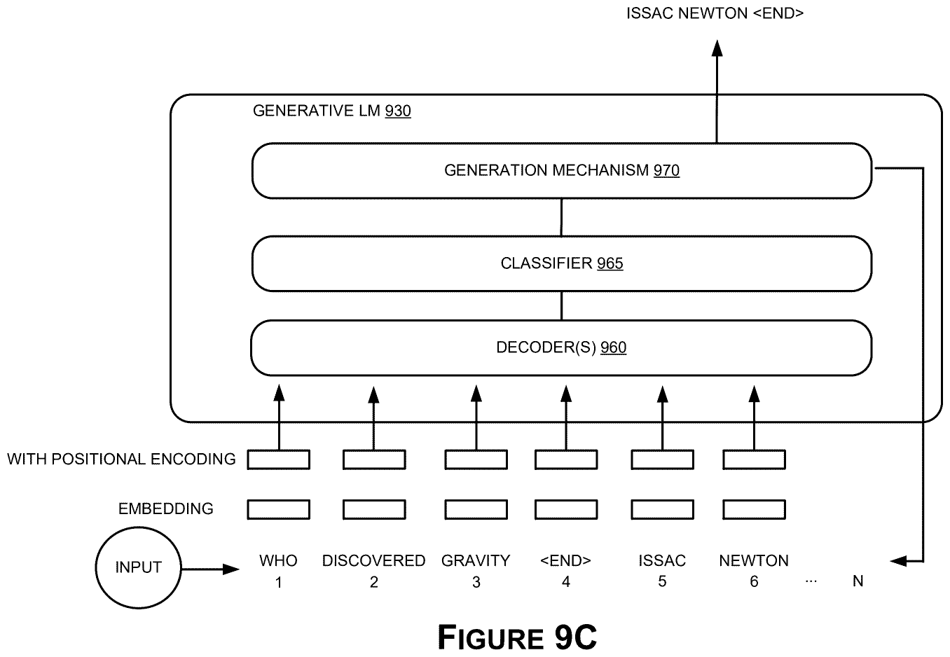

FIG. 9A is a block diagram of an example generative language model system 900 suitable for use in implementing at least some embodiments of the present disclosure. In the example illustrated in FIG. 9A, the generative language model system 900 includes a retrieval augmented generation (RAG) component 992, an input processor 905, a tokenizer 910, an embedding component 920, plug-ins/APIs 995, and a generative language model (LM) 930 (which may include an LLM, a VLM, a multi-modal LM, etc.).

At a high level, the input processor 905 may receive an input 901 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 930 (e.g., LLM/VLM/MMLM/etc.). In some embodiments, the input 901 includes plain text in the form of one or more sentences, paragraphs, and/or documents. Additionally or alternatively, the input 901 may include numerical sequences, precomputed embeddings (e.g., word or sentence embeddings), and/or structured data (e.g., in tabular formats, JSON, or XML). In some implementations in which the generative LM 930 is capable of processing multi-modal inputs, the input 901 may combine text (or may omit text) with image data, audio data, video data, design data, USD data, and/or other types of input data, such as but not limited to those described herein. Taking raw input text as an example, the input processor 905 may prepare raw input text in various ways. For example, the input processor 905 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 905 may remove stopwords to reduce noise and focus the generative LM 930 on more meaningful content. The input processor 905 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 992 (which may include one or more RAG models, and/or may be performed using the generative LM 930 itself) may be used to retrieve additional information to be used as part of the input 901 or prompt. RAG may be used to enhance the input to the LLM/VLM/MMLM/etc. with external knowledge, so that answers to specific questions or queries or requests are more relevant—such as in a case where specific knowledge is required. The RAG component 992 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 901 may be generated using the query or input to the model (e.g., a question, a request, etc.) in addition to data retrieved using the RAG component 992. In some embodiments, the input processor 905 may analyze the input 901 and communicate with the RAG component 992 (or the RAG component 992 may be part of the input processor 905, in embodiments) in order to identify relevant text and/or other data to provide to the generative LM 930 as additional context or sources of information from which to identify the response, answer, or output 990, generally. For example, where the input indicates that the user is interested in a desired tire pressure for a particular make and model of vehicle, the RAG component 992 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 992 may retrieve a prior stored conversation history—or at least a summary thereof—and include the prior conversation history along with the current ask/request as part of the input 901 to the generative LM 930.

The RAG component 992 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 992 and the embeddings of the chunks along with the embeddings of the query may be compared to identify the most similar/related embeddings to the query, which may be supplied to the generative LM 930 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may strore relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 992 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 910 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 930 to understand morphological variations and handle out-of-vocabulary words more effectively. Character-based tokenization represents each character as a separate token, enabling the generative LM 930 to process text at a fine-grained level. The choice of tokenization strategy may depend on factors such as the language being processed, the task at hand, and/or characteristics of the training dataset. As such, the tokenizer 910 may convert the (e.g., processed) text into a structured format according to tokenization schema being implemented in the particular embodiment.

The embedding component 920 may use any known embedding technique to transform discrete tokens into (e.g., dense, continuous vector) representations of semantic meaning. For example, the embedding component 920 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 901 includes image data/video data/etc., the input processor 901 may resize the data to a standard size compatible with format of a corresponding input channel and/or may normalize pixel values to a common range (e.g., 0 to 1) to ensure a consistent representation, and the embedding component 920 may encode the image data using any known technique (e.g., using one or more convolutional neural networks (CNNs) to extract visual features). In some implementations in which the input 901 includes audio data, the input processor 901 may resample an audio file to a consistent sampling rate for uniform processing, and the embedding component 920 may use any known technique to extract and encode audio features—such as in the form of a spectrogram (e.g., a mel-spectrogram). In some implementations in which the input 901 includes video data, the input processor 901 may extract frames or apply resizing to extracted frames, and the embedding component 920 may extract features such as optical flow embeddings or video embeddings and/or may encode temporal information or sequences of frames. In some implementations in which the input 901 includes multi-modal data, the embedding component 920 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 930 and/or other components of the generative LM system 900 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 920 may apply an encoded representation of the input 901 to the generative LM 930, and the generative LM 930 may process the encoded representation of the input 901 to generate an output 990, which may include responsive text and/or other types of data.

As described herein, in some embodiments, the generative LM 930 may be configured to access or use—or capable of accessing or using—plug-ins/APIs 995 (which may include one or more plug-ins, application programming interfaces (APIs), databases, data stores, repositories, etc.). For example, for certain tasks or operations that the generative LM 930 is not ideally suited for, the model may have instructions (e.g., as a result of training, and/or based on instructions in a given prompt, such as those retrieved using the RAG component 992) to access one or more plug-ins/APIs 995 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 995 to the plug-in/API 995, the plug-in/API 995 may process the information and return an answer to the generative LM 930, and the generative LM 930 may use the response to generate the output 990. This process may be repeated—e.g., recursively—for any number of iterations and using any number of plug-ins/APIs 995 until an output 990 that addresses each ask/question/request/process/operation/etc. from the input 901 can be generated. As such, the model(s) may not only rely on its own knowledge from training on a large dataset(s) and/or from data retrieved using the RAG component 992, but also on the expertise or optimized nature of one or more external resources—such as the plug-ins/APIs 995.

FIG. 9B is a block diagram of an example implementation in which the generative LM 930 includes a transformer encoder-decoder. For example, assume input text such as “Who discovered gravity” is tokenized (e.g., by the tokenizer 910 of FIG. 9A) into tokens such as words, and each token is encoded (e.g., by the embedding component 920 of FIG. 99A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 935 of the generative LM 930.

In an example implementation, the encoder(s) 935 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 940 may convert the context vector into attention vectors (keys and values) for the decoder(s) 945.

In an example implementation, the decoder(s) 945 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 935, in an example transformer architecture, each token (e.g., word) flows through a separate path in the decoder(s) 945. During a first pass, the decoder(s) 945, a classifier 950, and a generation mechanism 955 may generate a first token, and the generation mechanism 955 may apply the generated token as an input during a second pass. The process may repeat in a loop, successively generating and adding tokens (e.g., words) to the output from the preceding pass and applying the token embeddings of the composite sequence with positional encodings as an input to the decoder(s) 945 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 935, except that it creates its queries from the layer below it and takes the keys and values (e.g., matrix) from the output of the encoder(s) 935.

As such, the decoder(s) 945 may output some decoded (e.g., vector) representation of the input being applied during a particular pass. The classifier 950 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 955 may select or sample a word or token based on a corresponding predicted probability (e.g., select the word with the highest predicted probability) and append it to the output from a previous pass, generating each word or token sequentially. The generation mechanism 955 may repeat the process, triggering successive decoder inputs and corresponding predictions until selecting or sampling a symbol or token that represents the end of the response, at which point, the generation mechanism 955 may output the generated response.

FIG. 9C is a block diagram of an example implementation in which the generative LM 930 includes a decoder-only transformer architecture. For example, the decoder(s) 960 of FIG. 9C may operate similarly as the decoder(s) 945 of FIG. 9B except each of the decoder(s) 960 of FIG. 9C omits the encoder-decoder self-attention layer (since there is no encoder in this implementation). As such, the decoder(s) 960 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 960. As with the decoder(s) 945 of FIG. 9B, each token (e.g., word) may flow through a separate path in the decoder(s) 960, and the decoder(s) 960, a classifier 965, and a generation mechanism 970 may use auto-regression to sequentially generate one token at a time until predicting a symbol or token that represents the end of the response. The classifier 965 and the generation mechanism 970 may operate similarly as the classifier 950 and the generation mechanism 955 of FIG. 9B, with the generation mechanism 970 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Content Streaming System

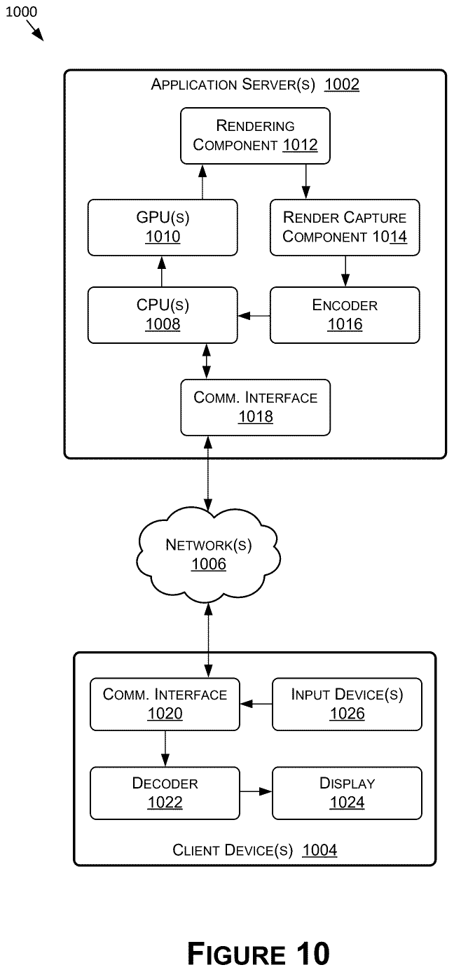

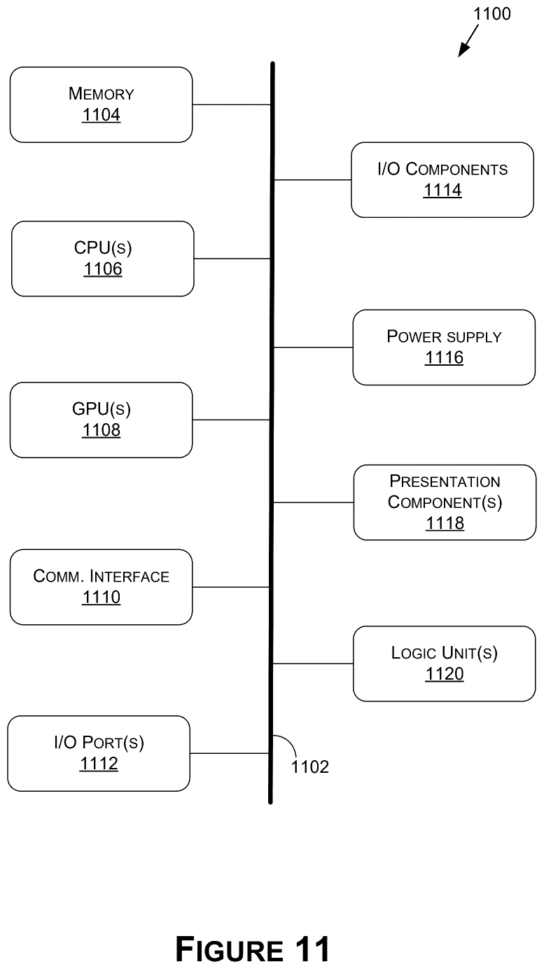

Now referring to FIG. 10, FIG. 10 is an example system diagram for a content streaming system 1000, in accordance with some embodiments of the present disclosure. FIG. 10 includes application server(s) 1002 (which may include similar components, features, and/or functionality to the example computing device 1100 of FIG. 11), client device(s) 1004 (which may include similar components, features, and/or functionality to the example computing device 1100 of FIG. 11), and network(s) 1006 (which may be similar to the network(s) described herein). In some embodiments of the present disclosure, the system 1000 may be implemented. The application session may correspond to a game streaming application (e.g., NVIDIA GeFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types.

In the system 1000, for an application session, the client device(s) 1004 may only receive input data in response to inputs to the input device(s), transmit the input data to the application server(s) 1002, receive encoded display data from the application server(s) 1002, and display the display data on the display 1024. As such, the more computationally intense computing and processing is offloaded to the application server(s) 1002 (e.g., rendering—in particular ray or path tracing—for graphical output of the application session is executed by the GPU(s) of the game server(s) 1002). In other words, the application session is streamed to the client device(s) 1004 from the application server(s) 1002, thereby reducing the requirements of the client device(s) 1004 for graphics processing and rendering.

For example, with respect to an instantiation of an application session, a client device 1004 may be displaying a frame of the application session on the display 1024 based on receiving the display data from the application server(s) 1002. The client device 1004 may receive an input to one of the input device(s) and generate input data in response. The client device 1004 may transmit the input data to the application server(s) 1002 via the communication interface 1020 and over the network(s) 1006 (e.g., the Internet), and the application server(s) 1002 may receive the input data via the communication interface 1018. The CPU(s) may receive the input data, process the input data, and transmit data to the GPU(s) that causes the GPU(s) to generate a rendering of the application session. For example, the input data may be representative of a movement of a character of the user in a game session of a game application, firing a weapon, reloading, passing a ball, turning a vehicle, etc. The rendering component 1012 may render the application session (e.g., representative of the result of the input data) and the render capture component 1014 may capture the rendering of the application session as display data (e.g., as image data capturing the rendered frame of the application session). The rendering of the application session may include ray or path-traced lighting and/or shadow effects, computed using one or more parallel processing units—such as GPUs, which may further employ the use of one or more dedicated hardware accelerators or processing cores to perform ray or path-tracing techniques—of the application server(s) 1002. In some embodiments, one or more virtual machines (VMs)—e.g., including one or more virtual components, such as vGPUs, vCPUs, etc.—may be used by the application server(s) 1002 to support the application sessions. The encoder 1016 may then encode the display data to generate encoded display data and the encoded display data may be transmitted to the client device 1004 over the network(s) 1006 via the communication interface 1018. The client device 1004 may receive the encoded display data via the communication interface 1020 and the decoder 1022 may decode the encoded display data to generate the display data. The client device 1004 may then display the display data via the display 1024.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

### Example Computing Device

FIG. 11 is a block diagram of an example computing device(s) 1100 suitable for use in implementing some embodiments of the present disclosure. Computing device 1100 may include an interconnect system 1102 that directly or indirectly couples the following devices: memory 1104, one or more central processing units (CPUs) 1106, one or more graphics processing units (GPUs) 1108, a communication interface 1110, input/output (I/O) ports 1112, input/output components 1114, a power supply 1116, one or more presentation components 1118 (e.g., display(s)), and one or more logic units 1120. In at least one embodiment, the computing device(s) 1100 may comprise one or more virtual machines (VMs), and/or any of the components thereof may comprise virtual components (e.g., virtual hardware components). For non-limiting examples, one or more of the GPUs 1108 may comprise one or more vGPUs, one or more of the CPUs 1106 may comprise one or more vCPUs, and/or one or more of the logic units 1120 may comprise one or more virtual logic units. As such, a computing device(s) 1100 may include discrete components (e.g., a full GPU dedicated to the computing device 1100), virtual components (e.g., a portion of a GPU dedicated to the computing device 1100), or a combination thereof.

Although the various blocks of FIG. 11 are shown as connected via the interconnect system 1102 with lines, this is not intended to be limiting and is for clarity only. For example, in some embodiments, a presentation component 1118, such as a display device, may be considered an I/O component 1114 (e.g., if the display is a touch screen). As another example, the CPUs 1106 and/or GPUs 1108 may include memory (e.g., the memory 1104 may be representative of a storage device in addition to the memory of the GPUs 1108, the CPUs 1106, and/or other components). As such, the computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11.

The interconnect system 1102 may represent one or more links or busses, such as an address bus, a data bus, a control bus, or a combination thereof. The interconnect system 1102 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1106 may be directly connected to the memory 1104. Further, the CPU 1106 may be directly connected to the GPU 1108. Where there is direct, or point-to-point connection between components, the interconnect system 1102 may include a PCIe link to carry out the connection. In these examples, a PCI bus need not be included in the computing device 1100.

The memory 1104 may include any of a variety of computer-readable media. The computer-readable media may be any available media that may be accessed by the computing device 1100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1104 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1100. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1106 may be configured to execute at least some of the computer-readable instructions to control one or more components of the computing device 1100 to perform one or more of the methods and/or processes described herein. The CPU(s) 1106 may each include one or more cores (e.g., one, two, four, eight, twenty-eight, seventy-two, etc.) that are capable of handling a multitude of software threads simultaneously. The CPU(s) 1106 may include any type of processor, and may include different types of processors depending on the type of computing device 1100 implemented (e.g., processors with fewer cores for mobile devices and processors with more cores for servers). For example, depending on the type of computing device 1100, the processor may be an Advanced RISC Machines (ARM) processor implemented using Reduced Instruction Set Computing (RISC) or an x86 processor implemented using Complex Instruction Set Computing (CISC). The computing device 1100 may include one or more CPUs 1106 in addition to one or more microprocessors or supplementary co-processors, such as math co-processors.

In addition to or alternatively from the CPU(s) 1106, the GPU(s) 1108 may be configured to execute at least some of the computer-readable instructions to control one or more components of the computing device 1100 to perform one or more of the methods and/or processes described herein. One or more of the GPU(s) 1108 may be an integrated GPU (e.g., with one or more of the CPU(s) 1106 and/or one or more of the GPU(s) 1108 may be a discrete GPU. In embodiments, one or more of the GPU(s) 1108 may be a coprocessor of one or more of the CPU(s) 1106. The GPU(s) 1108 may be used by the computing device 1100 to render graphics (e.g., 3D graphics) or perform general purpose computations. For example, the GPU(s) 1108 may be used for General-Purpose computing on GPUs (GPGPU). The GPU(s) 1108 may include hundreds or thousands of cores that are capable of handling hundreds or thousands of software threads simultaneously. The GPU(s) 1108 may generate pixel data for output images in response to rendering commands (e.g., rendering commands from the CPU(s) 1106 received via a host interface). The GPU(s) 1108 may include graphics memory, such as display memory, for storing pixel data or any other suitable data, such as GPGPU data. The display memory may be included as part of the memory 1104. The GPU(s) 1108 may include two or more GPUs operating in parallel (e.g., via a link). The link may directly connect the GPUs (e.g., using NVLINK) or may connect the GPUs through a switch (e.g., using NVSwitch). When combined together, each GPU 1108 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1106 and/or the GPU(s) 1108, the logic unit(s) 1120 may be configured to execute at least some of the computer-readable instructions to control one or more components of the computing device 1100 to perform one or more of the methods and/or processes described herein. In embodiments, the CPU(s) 1106, the GPU(s) 1108, and/or the logic unit(s) 1120 may discretely or jointly perform any combination of the methods, processes and/or portions thereof. One or more of the logic units 1120 may be part of and/or integrated in one or more of the CPU(s) 1106 and/or the GPU(s) 1108 and/or one or more of the logic units 1120 may be discrete components or otherwise external to the CPU(s) 1106 and/or the GPU(s) 1108. In embodiments, one or more of the logic units 1120 may be a coprocessor of one or more of the CPU(s) 1106 and/or one or more of the GPU(s) 1108.

Examples of the logic unit(s) 1120 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1110 may include one or more receivers, transmitters, and/or transceivers that allow the computing device 1100 to communicate with other computing devices via an electronic communication network, included wired and/or wireless communications. The communication interface 1110 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1120 and/or communication interface 1110 may include one or more data processing units (DPUs) to transmit data received over a network and/or through interconnect system 1102 directly to (e.g., a memory of) one or more GPU(s) 1108.

The I/O ports 1112 may allow the computing device 1100 to be logically coupled to other devices including the I/O components 1114, the presentation component(s) 1118, and/or other components, some of which may be built in to (e.g., integrated in) the computing device 1100. Illustrative I/O components 1114 include a microphone, mouse, keyboard, joystick, game pad, game controller, satellite dish, scanner, printer, wireless device, etc. The I/O components 1114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1100. The computing device 1100 may be include depth cameras, such as stereoscopic camera systems, infrared camera systems, RGB camera systems, touchscreen technology, and combinations of these, for gesture detection and recognition. Additionally, the computing device 1100 may include accelerometers or gyroscopes (e.g., as part of an inertia measurement unit (IMU)) that allow detection of motion. In some examples, the output of the accelerometers or gyroscopes may be used by the computing device 1100 to render immersive augmented reality or virtual reality.

The power supply 1116 may include a hard-wired power supply, a battery power supply, or a combination thereof. The power supply 1116 may provide power to the computing device 1100 to allow the components of the computing device 1100 to operate.

The presentation component(s) 1118 may include a display (e.g., a monitor, a touch screen, a television screen, a heads-up-display (HUD), other display types, or a combination thereof), speakers, and/or other presentation components. The presentation component(s) 1118 may receive data from other components (e.g., the GPU(s) 1108, the CPU(s) 1106, DPUs, etc.), and output the data (e.g., as an image, video, sound, etc.).

### Example Data Center

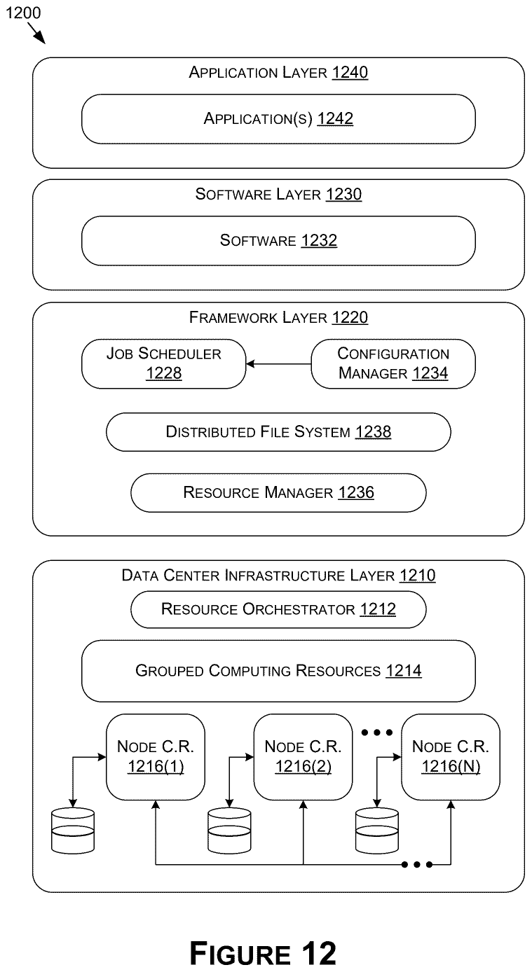

FIG. 12 illustrates an example data center 1200 that may be used in at least one embodiments of the present disclosure. The data center 1200 may include a data center infrastructure layer 1210, a framework layer 1220, a software layer 1230, and/or an application layer 1240.

As shown in FIG. 12, the data center infrastructure layer 1210 may include a resource orchestrator 1212, grouped computing resources 1214, and node computing resources (“node C.R.s”) 1216(1)-1216(N), where “N” represents any whole, positive integer. In at least one embodiment, node C.R.s 1216(1)-1216(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R. s from among node C.R.s 1216(1)-1216(N) may correspond to a server having one or more of the above-mentioned computing resources. In addition, in some embodiments, the node C.R.s 1216(1)-12161(N) may include one or more virtual components, such as vGPUs, vCPUs, and/or the like, and/or one or more of the node C.R.s 1216(1)-1216(N) may correspond to a virtual machine (VM).

In at least one embodiment, grouped computing resources 1214 may include separate groupings of node C.R.s 1216 housed within one or more racks (not shown), or many racks housed in data centers at various geographical locations (also not shown). Separate groupings of node C.R.s 1216 within grouped computing resources 1214 may include grouped compute, network, memory or storage resources that may be configured or allocated to support one or more workloads. In at least one embodiment, several node C.R.s 1216 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1212 may configure or otherwise control one or more node C.R.s 1216(1)-1216(N) and/or grouped computing resources 1214. In at least one embodiment, resource orchestrator 1212 may include a software design infrastructure (SDI) management entity for the data center 1200. The resource orchestrator 1212 may include hardware, software, or some combination thereof.

In at least one embodiment, as shown in FIG. 12, framework layer 1220 may include a job scheduler 1228, a configuration manager 1234, a resource manager 1236, and/or a distributed file system 1238. The framework layer 1220 may include a framework to support software 1232 of software layer 1230 and/or one or more application(s) 1242 of application layer 1240. The software 1232 or application(s) 1242 may respectively include web-based service software or applications, such as those provided by Amazon Web Services, Google Cloud and Microsoft Azure. The framework layer 1220 may be, but is not limited to, a type of free and open-source software web application framework such as Apache Spark^{TM} (hereinafter “Spark”) that may use distributed file system 1238 for large-scale data processing (e.g., “big data”). In at least one embodiment, job scheduler 1228 may include a Spark driver to facilitate scheduling of workloads supported by various layers of data center 1200. The configuration manager 1234 may be capable of configuring different layers such as software layer 1230 and framework layer 1220 including Spark and distributed file system 1238 for supporting large-scale data processing. The resource manager 1236 may be capable of managing clustered or grouped computing resources mapped to or allocated for support of distributed file system 1238 and job scheduler 1228. In at least one embodiment, clustered or grouped computing resources may include grouped computing resource 1214 at data center infrastructure layer 1210. The resource manager 1236 may coordinate with resource orchestrator 1212 to manage these mapped or allocated computing resources.

In at least one embodiment, software 1232 included in software layer 1230 may include software used by at least portions of node C.R.s 1216(1)-1216(N), grouped computing resources 1214, and/or distributed file system 1238 of framework layer 1220. One or more types of software may include, but are not limited to, Internet web page search software, e-mail virus scan software, database software, and streaming video content software.

In at least one embodiment, application(s) 1242 included in application layer 1240 may include one or more types of applications used by at least portions of node C.R.s 1216(1)-1216(N), grouped computing resources 1214, and/or distributed file system 1238 of framework layer 1220. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1234, resource manager 1236, and resource orchestrator 1212 may implement any number and type of self-modifying actions based on any amount and type of data acquired in any technically feasible fashion. Self-modifying actions may relieve a data center operator of data center 1200 from making possibly bad configuration decisions and possibly avoiding underutilized and/or poor performing portions of a data center.

The data center 1200 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1200. In at least one embodiment, trained or deployed machine learning models corresponding to one or more neural networks may be used to infer or predict information using resources described above with respect to the data center 1200 by using weight parameters calculated through one or more training techniques, such as but not limited to those described herein.

In at least one embodiment, the data center 1200 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1100 of FIG. 11—e.g., each device may include similar components, features, and/or functionality of the computing device(s) 1100. In addition, where backend devices (e.g., servers, NAS, etc.) are implemented, the backend devices may be included as part of a data center 1200, an example of which is described in more detail herein with respect to FIG. 12.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1100 described herein with respect to FIG. 11. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Clauses

A: A method comprising: applying, to one or more machine learning models, input data representative of at least one or more frames associated with one or more interactive applications; determining, based at least on the one or more machine learning models processing the input data, output data representative of one or more instructions for the one or more interactive applications to execute; comparing the one or more instructions to one or more ground truth instructions associated with the one or more frames; and updating, based at least on the comparing, at least one parameter of the one or more machine learning models.

B: The method of paragraph A, wherein the input data is further representative of at least one of: one or more second instructions associated with the one or more frames; or one or more inputs associated with the one or more frames; one or more points associated with a point cloud of an object depicted in the one or more frames; one or more maps corresponding to at least a portion of an environment depicted in the one or more frames; or speech at least partially aligned temporally with content depicted in the one or more frames.

C: The method of either paragraph A or paragraph B, further comprising: generating, based at least on one or more second machine learning models processing second input data representative of one or more second frames associated with the one or more interactive applications, second output data representative of the one or more ground truth instructions, wherein the one or more second frames are subsequent in time to the one or more frames.

D: The method of paragraph C, wherein the second input data is further representative of at least one of: one or more associations between one or more inputs and one or more actions corresponding to the one or more interactive applications; one or more inputs associated with the one or more second frames; one or more descriptions associated with the one or more interactive applications; one or more captions associated with the one or more second frames; location information associated with one or more objects depicted by the one or more second frames; or a prompt to generate the one or more ground truth instructions.

E: The method of any one of paragraphs A-D, further comprising: obtaining audio data representative of user speech associated with the one or more frames; and determining, based at least on the user speech, the one or more ground truth instructions.

F: The method of paragraph E, further comprising: determining, based at least on one or more language models processing the audio data, at least a portion of the user speech that is associated with a primary user from one or more users, wherein the determining the one or more ground truth instructions is based on at least the portion of the user speech.

G: The method of paragraph E, further comprising: generating, based at least on one or more second machine learning models processing the audio data, transcripts associated with the user speech; and determining, based at least on one or more third machine learning models processing second input data associated with the transcripts, that one or more transcripts from the transcripts are relevant to the one or more frames, wherein the determining the one or more ground truth instructions is based at least on the one or more transcripts.

H: The method of any one of paragraphs A-G, wherein: the output data is further representative of at least one of one or more inputs or one or more second frames associated with the one or more interactive applications; and the updating the at least one parameter is further based at least on at least one of: comparing the one or more inputs to one or more ground truth inputs; or comparing the one or more second frames to one or more ground truth frames.

I: The method of any one of paragraphs A-H, further comprising: determining, based at least on the one or more machine learning models processing second input data representative of one or more second frames associated with a second interactive application, one or more second instructions; and performing one or more operations based at least on the one or more second instructions.

J: A system comprising: one or more processors to: apply, to one or more machine learning models, input data representative of one or more frames associated with an interactive application and one or more inputs associated with the one or more frames; determine, based at least on the one or more machine learning models processing the input data, output data representative of one or more instructions to perform with regard to the interactive application; and perform one or more operations based at least on the one or more instructions.

K: The system of paragraph J, wherein the input data is further representative of one or more previous instructions performed with respect to the interactive application.

L: The system of either paragraph J or K, wherein at least one operation of the one or more operations comprises: outputting content indicating the one or more instructions; or causing one or more actions associated with the one or more instructions to occur with respect to the interactive application.

M: The system of any one of paragraphs J-L, wherein to determine the one or more inputs, the one or more processors are further to obtain at least one of: input data representative of the one or more inputs; audio data representative of the one or more inputs; or the one or more inputs from one or more previous instructions.

N: The system of any one of paragraphs J-M wherein the one or more machine learning models are trained at least by: determining, based at least on the one or more machine learning models processing second input data representative of one or more second frames associated with one or more second interactive applications, second output data representative of one or more second instructions to perform for the one or more second interactive applications; comparing the one or more second instructions to one or more ground truth instructions associated with the one or more second frames; and updating, based at least on the comparing, at least one of one or more parameters or one or more weights of the one or more machine learning models.

O: The system of paragraph N, wherein the one or more ground truth data instructions are generated based at least on one or more second machine learning models processing third input data representative of one or more third frames associated with the one or more second interactive applications, the one or more third frames being subsequent to the one or more second frames.

P: The system of paragraph N, wherein the one or more ground truth instructions are determined based at least on audio data representative of user speech associated with the one or more second frames.

Q: The system of any one of paragraphs J-P, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

R: One or more processors comprising: processing circuitry to: determine, based at least on one or more machine learning models processing input data representative of one or more frames associated with one or more interactive applications, output data representing one or more instructions to perform for the one or more interactive application; and update, based at least on the one or more instructions and one or more ground truth instructions, the one or more machine learning models.

S: The one or more processors of paragraph R, wherein the input data is further representative of: one or more second instructions associated with the one or more frames; or one or more inputs associated with the one or more frames.

T: The one or more processors of either paragraph R or paragraph S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

What is claimed is:

1. A method comprising:
applying, to one or more machine learning models, input data representative of at least one or more frames associated with one or more interactive applications;
determining, based at least on the one or more machine learning models processing the input data, output data representative of one or more instructions for the one or more interactive applications to execute;
comparing the one or more instructions to one or more ground truth instructions associated with the one or more frames; and
updating, based at least on the comparing, at least one parameter of the one or more machine learning models.

2. The method of claim 1, wherein the input data is further representative of at least one of:
one or more second instructions associated with the one or more frames; or
one or more inputs associated with the one or more frames;
one or more points associated with a point cloud of an object depicted in the one or more frames;
one or more maps corresponding to at least a portion of an environment depicted in the one or more frames; or
speech at least partially aligned temporally with content depicted in the one or more frames.

3. The method of claim 1, further comprising:
generating, based at least on one or more second machine learning models processing second input data representative of one or more second frames associated with the one or more interactive applications, second output data representative of the one or more ground truth instructions,
wherein the one or more second frames are subsequent in time to the one or more frames.

4. The method of claim 3, wherein the second input data is further representative of at least one of:
one or more associations between one or more inputs and one or more actions corresponding to the one or more interactive applications;
one or more inputs associated with the one or more second frames;
one or more descriptions associated with the one or more interactive applications;
one or more captions associated with the one or more second frames;
location information associated with one or more objects depicted by the one or more second frames; or
a prompt to generate the one or more ground truth instructions.

5. The method of claim 1, further comprising:
obtaining audio data representative of user speech associated with the one or more frames; and
determining, based at least on the user speech, the one or more ground truth instructions.

6. The method of claim 5, further comprising:
determining, based at least on one or more language models processing the audio data, at least a portion of the user speech that is associated with a primary user from one or more users,
wherein the determining the one or more ground truth instructions is based on at least the portion of the user speech.

7. The method of claim 5, further comprising:
generating, based at least on one or more second machine learning models processing the audio data, transcripts associated with the user speech; and
determining, based at least on one or more third machine learning models processing second input data associated with the transcripts, that one or more transcripts from the transcripts are relevant to the one or more frames,
wherein the determining the one or more ground truth instructions is based at least on the one or more transcripts.

8. The method of claim 1, wherein:
the output data is further representative of at least one of one or more inputs or one or more second frames associated with the one or more interactive applications; and
the updating the at least one parameter is further based at least on at least one of:
comparing the one or more inputs to one or more ground truth inputs; or
comparing the one or more second frames to one or more ground truth frames.

9. The method of claim 1, further comprising:
determining, based at least on the one or more machine learning models processing second input data representative of one or more second frames associated with a second interactive application, one or more second instructions; and
performing one or more operations based at least on the one or more second instructions.

10. A system comprising:
one or more processors to:
apply, to one or more machine learning models, input data representative of one or more frames associated with an interactive application and one or more inputs associated with the one or more frames;
determine, based at least on the one or more machine learning models processing the input data, output data representative of one or more instructions to perform with regard to the interactive application; and
perform one or more operations based at least on the one or more instructions.

11. The system of claim 10, wherein the input data is further representative of one or more previous instructions performed with respect to the interactive application.

12. The system of claim 10, wherein at least one operation of the one or more operations comprises:
outputting content indicating the one or more instructions; or
causing one or more actions associated with the one or more instructions to occur with respect to the interactive application.

13. The system of claim 10, wherein to determine the one or more inputs, the one or more processors are further to obtain at least one of:
input data representative of the one or more inputs;
audio data representative of the one or more inputs; or
the one or more inputs from one or more previous instructions.

14. The system of claim 10, wherein the one or more machine learning models are trained at least by:
determining, based at least on the one or more machine learning models processing second input data representative of one or more second frames associated with one or more second interactive applications, second output data representative of one or more second instructions to perform for the one or more second interactive applications;
comparing the one or more second instructions to one or more ground truth instructions associated with the one or more second frames; and
updating, based at least on the comparing, at least one of one or more parameters or one or more weights of the one or more machine learning models.

15. The system of claim 14, wherein the one or more ground truth data instructions are generated based at least on one or more second machine learning models processing third input data representative of one or more third frames associated with the one or more second interactive applications, the one or more third frames being subsequent to the one or more second frames.

16. The system of claim 14, wherein the one or more ground truth instructions are determined based at least on audio data representative of user speech associated with the one or more second frames.

17. The system of claim 10, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
systems implementing one or more multi-modal language models;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.

18. One or more processors comprising:
processing circuitry to:
determine, based at least on one or more machine learning models processing input data representative of one or more frames associated with one or more interactive applications, output data representing one or more instructions to perform for the one or more interactive application; and
update, based at least on the one or more instructions and one or more ground truth instructions, the one or more machine learning models.

19. The one or more processors of claim 18, wherein the input data is further representative of:
one or more second instructions associated with the one or more frames; or
one or more inputs associated with the one or more frames.

20. The one or more processors of claim 18, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
systems implementing one or more multi-modal language models;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.
